(19) United States
(12) Patent Application Publication
(10) Pub. No.: US 2025/0373448 A1
(43) Pub. Date: Dec. 4, 2025

(54) COMMUNICATION SYSTEM, TERMINAL DEVICE, COMMUNICATION DEVICE, CERTIFICATE AUTHORITY, AND METHOD

(71) Applicant: KABUSHIKI KAISHA TOSHIBA, Tokyo (JP)

(72) Inventors: Toshio ITO, Yokohama (JP); Yasuyuki TANAKA, Kawasaki (JP)

(73) Assignee: KABUSHIKI KAISHA TOSHIBA, Tokyo (JP)

(21) Appl. No.: 19/058,646

(22) Filed: Feb. 20, 2025

(30) Foreign Application Priority Data
May 29, 2024 (JP) 2024-087025

(51) Int. Cl. H04L 9/32; H04L 9/30

(52) U.S. Cl. CPC H04L 9/3263; H04L 9/30

(57) ABSTRACT

According to one embodiment, a communication system includes a communication device, a terminal device, and a certificate authority. The communication device sends, to the terminal device, a certificate signing request which includes device information, an attestation nonce, and an electronic signature generated using a private key. The terminal device sends the certificate signing request to the certificate authority. Verification of the electronic signature included in the certificate signing request is executed using a public key. The certificate authority issues a certificate in response to the verification result.

### CROSS-REFERENCE TO RELATED APPLICATIONS

This application is based upon and claims the benefit of priority from Japanese Patent Application No. 2024-087025, filed May 29, 2024, the entire contents of which are incorporated herein by reference.

### FIELD

Embodiments described herein relate generally to a communication system, a terminal device, a communication device, a certificate authority, and a method.

### BACKGROUND

In the technology known as the Internet of Things (IoT), various IoT services can be realized by connecting edge devices (communication devices) to a network.

In order for the edge device mentioned above to communicate with a server device which provides IoT services via the network, a certificate to ensure security for the communication (for example, a certificate for a public key of the edge device in public key cryptography) is necessary but, for example, much labor is required to issue the certificate on the user side who owns the edge device.

### BRIEF DESCRIPTION OF THE DRAWINGS

FIG. 1 is a view showing an example of a system configuration of a communication system according to a first embodiment.

FIG. 2 is a view showing an example of a functional configuration of an edge device.

FIG. 3 is a table showing an example of device information.

FIG. 4 is a view showing an example of a functional configuration of a user terminal.

FIG. 5 is a table showing an example of user information.

FIG. 6 is a view showing an example of server information.

FIG. 7 is a view showing an example of a functional configuration of a certificate authority.

FIG. 8 is a table showing an example of information managed by an attestation nonce management module.

FIG. 9 is a table showing an example of information managed by an attestation key management module.

FIG. 10 is a view showing an example of the hardware configuration of the edge device.

FIG. 11 is a sequence chart showing an example of a procedure of a communication system.

FIG. 12 is a view showing an example of a device confirmation screen.

FIG. 13 is a table showing an example of verification information.

FIG. 14 is a table showing another example of the verification information.

FIG. 15 is a table showing yet another example of the verification information.

FIG. 16 is a table showing yet another example of the verification information.

FIG. 17 is a table showing an example of issuance history information.

FIG. 18 is a view showing an overview of issuance of a public key certificate according to a first comparative example of the embodiment.

FIG. 19 is a view showing an overview of issuance of a public key certificate in the embodiment.

FIG. 20 is a view illustrating security threats in a second comparative example of the embodiment.

FIG. 21 is a view illustrating security effects in the embodiment.

FIG. 22 is a view showing an example of a system configuration of a communication system according to a second embodiment.

FIG. 23 is a view showing an example of a functional configuration of a user terminal.

FIG. 24 is a view showing an example of a functional configuration of a certificate authority.

FIG. 25 is a view showing an example of a functional configuration of a server device.

FIG. 26 is a sequence chart showing an example of a procedure of a communication system.

FIG. 27 is a view showing an example of a functional configuration of a user terminal according to a third embodiment.

FIG. 28 is a view showing an example of a functional configuration of a certificate authority.

FIG. 29 is a table showing an example of information managed by an attestation secret management module.

FIG. 30 is a sequence chart showing an example of a procedure of a communication system.

FIG. 31 is a view showing an example of a functional configuration of a certificate authority according to a fourth embodiment.

FIG. 32 is a table showing an example of agent information.

FIG. 33 is a view illustrating a specific usage of the communication system.

### DETAILED DESCRIPTION

In general, according to one embodiment, a communication system includes a communication device, a terminal device, and a certificate authority. The communication device is configured to send, to the terminal device, a certificate signing request which requests issuance of a certificate used for the communication device to communicate with a server device, and which includes device information on the communication device, an attestation nonce, and an electronic signature generated using a private key for attestation as held in advance in the communication device for the device information and the attestation nonce. The terminal device is configured to send the certificate signing request sent from the communication device, to the certificate authority. Verification of the electronic signature included in the certificate signing request is executed using a public key for attestation, which is paired with the private key for attestation. The certificate authority is configured to issue the certificate in response to the verification result.

Various embodiments will be described with reference to the accompanying drawings.

### First Embodiment

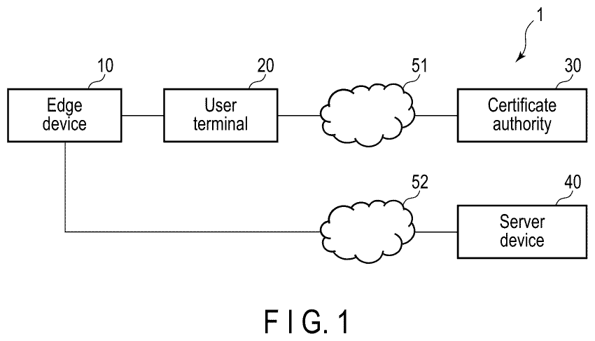

First, a first embodiment will be described. FIG. 1 shows an example of a system configuration of a communication system according to the embodiment. As shown in FIG. 1, a communication system 1 includes an edge device 10, a user terminal 20 (client terminal), a certificate authority 30, and a server device 40.

The edge device 10 is a device used in technology referred to as IoT, and is equipped with a host controller configured to control the operation of the edge device 10 and a communication device configured to provide a communication function to the edge device 10.

Incidentally, for example, the host controller and the communication device are connected via a connection interface provided in the edge device 10 such as a USB connector or a pin slot connector. For example, however, serial communication such as I2C, URT and SPI or parallel communication may be executed between the host controller and the communication device.

In the embodiment, the edge device 10 may be simply referred to as a communication device, and includes IoT devices, personal computers (PC), gateways, or the like. The edge device 10 operates as part of an application system for providing various IoT services by communicating with the server device 40. However, in the embodiment, it is assumed that since the edge device 10 is in a factory default condition, settings necessary for communicating with the server device 40 are not made. Incidentally, the edge device 10 in the factory default condition may be a device that has been used for other purposes in the past and then returned to the factory default condition (i.e., initialized) by executing a predetermined operation.

The user terminal 20 is assumed to be, for example, a handheld terminal such as a smartphone or a tablet terminal used by the user who owns the edge device 10, but may also be a terminal device of the other form such as a PC. The user terminal 20 includes a user interface which accepts user input and presents information to the user.

The certificate authority (certification apparatus) 30 is an information processing apparatus configured to issue certificates used by the edge device 10 to communicate with the server device 40. More specifically, when public key cryptography is employed to ensure security in the communication executed between the edge device 10 and the server device 40, the certificate authority 30 issues a certificate for a public key of the edge device 10 in the public key cryptography (i.e., a public key certificate of the edge device 10). When the public key certificate thus issued by the certificate authority 30 is registered in the edge device 10, the edge device 10 becomes able to communicate with the server device 40 using the public key certificate.

The server device 40 operates to provide various IoT services by communicating with the edge device 10. More specifically, for example, the server device 40 may operate to register sensor data collected (measured) by the edge device 10 in the server device 40 or may operate to issue commands to the edge device 10 and cause the edge device 10 to execute a predetermined process. Furthermore, the server device 40 may send firmware or software which operates on the edge device 10 to the edge device 10 and instruct the edge device 10 to update the firmware or the software.

For example, the above-described processing of the server device 40 may be executed on a server computer managed on-premises at a location such as a business office or may be executed on a virtual computer realized on the computer. In addition, the processing of the server device 40 may be executed on a cloud substrate in a communication network or on the Internet provided by a cloud service provider or the like.

Incidentally, the communication method applied to the communication between the edge device 10 and the user terminal 20 shown in FIG. 1 may be a wireless communication method or a wired communication method. Examples of wireless communication methods include Bluetooth (registered trademark), Wi-Fi (registered trademark), ZigBee (registered trademark), and infrared communication, but is not limited to these. Examples of wired communication methods include Ethernet (registered trademark), serial communication using Universal Asynchronous Receiver Transmitter (UART), and Controller Area Network (CAN), but is not limited to these.

In addition, the user terminal 20 and the certificate authority 30 shown in FIG. 1 are connected communicably with each other via a network 51. In addition, the edge device 10 and the server device 40 shown in FIG. 1 are connected communicably with each other via a network 52.

The communication method applied to the communication between the user terminal 20 and the network 51, and the communication method applied to the communication between the edge device 10 and the network 52, may be a wireless communication method or a wired communication method, similarly to the communication method applied to the above-described communication between the edge device 10 and the user terminal 20. The communication method applied to the communication between the certificate authority 30 and the network 51, and the communication method applied to the communication between the server device 40 and the network 52 may also be a wireless or wired communication method.

In addition, for example, the network 51 may be a small-scale, closed network such as a local area network (LAN), or a wide-area, closed network such as a wide area network (WAN), or an open network such as the Internet. In addition, the user terminal 30 executes communication based on, for example, Wifi and cellular communication methods (such as LTE or 5G) to connect to the network 51, but may be configured to execute communication based on other standards. The network 51 has been described here, but the network 52 is configured in the same manner. Incidentally, the above-described networks 51 and 52 may be different networks or the same network.

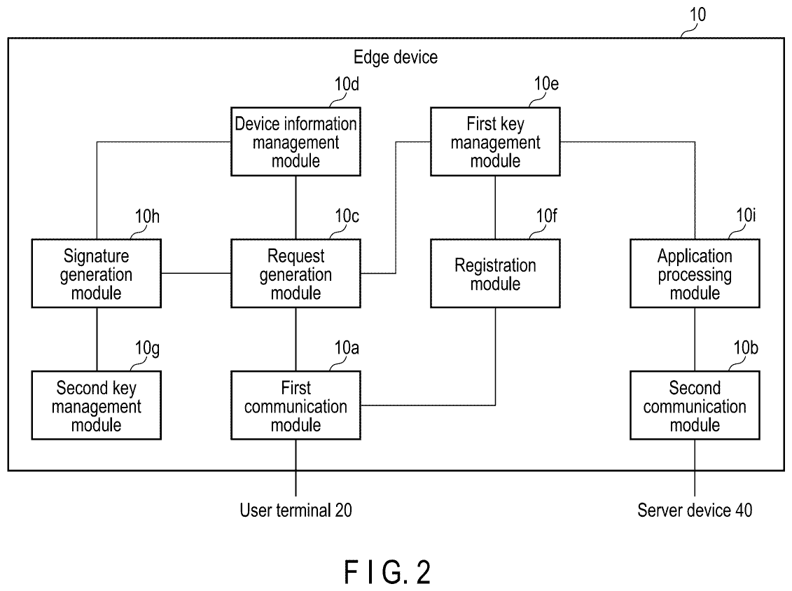

FIG. 2 shows an example of the functional configuration of the edge device 10 shown in FIG. 1. As shown in FIG. 2, the edge device 10 includes a first communication module 10a, a second communication module 10b, a request generation module 10c, a device information management module 10d, a first key management module 10e, a registration module 10f, a second key management module 10g, a signature generation module 10h, and an application processing module 10l.

The first communication module 10a executes communication with the user terminal 20 in accordance with a predetermined communication method. In addition, the second communication module 10b executes communication with the server device 40 via the network 52.

Incidentally, in FIG. 2, the first and second communication modules 10a and 10b are shown as separate, independent functional modules, but the first and second communication modules 10a and 10b may be implemented as a single functional module. In addition, the communication method used by the first communication module 10a to execute communication may be different from or the same as the communication method used by the second communication module 10b to execute communication.

The request generation module 10c generates a certificate signing request that requests issuance of a public key certificate in accordance with instructions from the user terminal 20 to be described below. The certificate signing request generated by the request generation module 10c is sent from the first communication module 10a to the user terminal 20.

The device information management module 10d manages information on the edge device 10 (hereinafter referred to as device information).

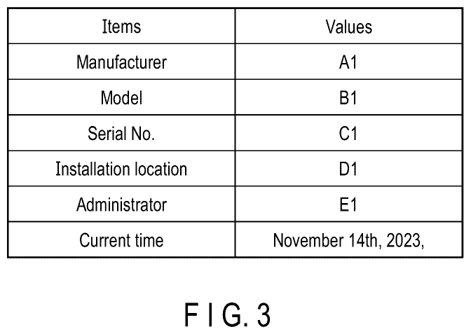

FIG. 3 shows an example of the device information. In the example shown in FIG. 3, the device information includes, for example, the manufacturer, model, serial number, installation location, administrator, and current time of the edge device 10.

The manufacturer, model, and serial number are, for example, information that is embedded in advance when the edge device 10 is manufactured (in other words, information that is registered in advance in the edge device 10). The installation location and the administrator are, for example, information provided by the user terminal 20. The current time is initialized by, for example, information provided by the user terminal 20 and is automatically updated as elapse of the time.

In FIG. 3, it has been described that the device information includes the manufacturer, model, serial number, installation location, administrator, and current time. In the device information, however, some of elements of the information may be omitted or information other than the information (for example, model number, hardware version, and the like) may be included.

In addition, the device information management module 10d may be located in, for example, hardware in which the device information cannot be rewritten from the outside.

The first key management module 10e manages the public key and private key (key pair) of the edge device 10 in the public key cryptography.

Incidentally, the certificate signing request generated by the above-described request generation module 10c includes the public key of the edge device 10 managed by the first key management module 10e.

In this example, the key pair of the edge device 10 may be generated in response to instructions from the request generation module 10c, for example, when the request generation module 10c generates the certificate signing request, and may also be generated, for example, when the power of the edge device 10 is turned on in a factory default condition. In addition, the key pair of the edge device 10 may be generated in response to instructions from the user terminal 20. Furthermore, the key pair of the edge device 10 may be stored in advance in the edge device 10. In addition, if the first key management module 10e is implemented as a security module of hardware such as a secure element, the key pair of the edge device 10 may be generated by the hardware.

It has been described that the first key management module 10e mainly manages the key pair of the edge device 10. However, the first key management module 10e may also execute cryptographic processing and signature processing based on the public key cryptography.

The registration module 10f executes a process of registering in the edge device 10 (first key management module 10e) the public key certificate issued by the certificate authority 30 in response to the certificate signing request generated by the request generation module 10c.

The second key management module 10g manages the public key and the private key for proving that the edge device 10 is a legitimate or trustworthy device in the embodiment (i.e., public and private keys for Incidentally, this pair of public and attestation). private keys for attestation (asymmetric encryption key pair) is referred to as attestation keys. The attestation keys are generated by the manufacturer of the edge device 10 and written to the second key management module 10g at the time of manufacturing the edge device 10 (in other words, held in advance in the edge device 10). In addition, the second key management module 10g manages the key ID (hereinafter referred to as an attestation key ID) for identifying the attestation keys (i.e., the pair of public and private keys for attestation).

The signature generation module 10h generates an electronic signature using the attestation key (the private key for attestation) for the device information (i.e., information such as manufacturer, model, and serial number) and (the data including) the attestation nonce managed by the device information management module 10d. In the following descriptions, this electronic signature is referred to as an attestation signature. Incidentally, the attestation nonce is a random number that is used only once (for example, a discarded random character string), and is provided by the user terminal 20.

The device information, the attestation nonce, the attestation signature, and the attestation key ID described above are delivered to the request generation module 10c, and are included in the certificate signing request generated by the request generation module 10c.

Incidentally, the second key management module 10g is assumed to be, in principle, located in hardware whose data cannot be read from or written to the outside (other than the signature generation module 10h). In other words, in the embodiment, the attestation key is assumed to be managed to be used by only the signature generation module 10h (i.e., only the signature generation module 10h can generate the attestation signature).

The application processing module 10i uses the public key certificate registered in the edge device 10 to execute an authentication process (hereinafter referred to as device authentication process) for the edge device 10 with the server device 40.

When the edge device 10 is authenticated (i.e., authentication is successful) by executing the device authentication process, the application processing module 10i executes communication (application communication) with the server device 40 via the second communication module 10b. In addition, the application processing module 10i executes the processing on the edge device 10 side for providing IoT services (i.e., the application processing corresponding to the application communication). In this case, the application processing module 10i may execute processing of acquiring sensor data from a sensor mounted on the edge device 10 and sending the sensor data to the server device 40. In addition, the application processing module 10i may execute processing of executing commands on the edge device 10 or operating an actuator connected to the edge device 10 in accordance with instructions from the server device 40. Furthermore, the application processing module 10i may execute processing of updating the firmware or software of the edge device 10 in accordance with instructions from the server device 40.

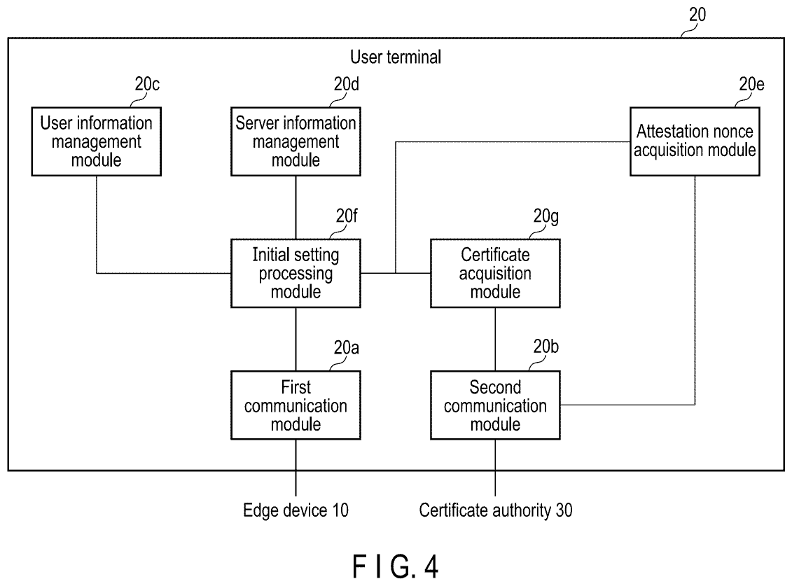

FIG. 4 shows an example of a functional configuration of the user terminal 20 shown in FIG. 1. As shown in FIG. 4, the user terminal 20 includes a first communication module 20a, a second communication module 20b, a user information management module 20c, a server information management module 20d, an attestation nonce acquisition module 20e, an initial setting processing module 20f, and a certificate acquisition module 20g.

The first communication module 20a executes communication with the edge device 10 in accordance with a predetermined communication method. In addition, the second communication module 20b executes communication with the certificate authority 30 via the network 51.

Incidentally, in FIG. 4, the first and second communication modules 20a and 20b are shown as separate, independent functional modules. However, these first and second communication modules 20a and 20b may be implemented as a single functional module. In addition, the communication method used by the first communication module 20a to communicate may be different from or the same as the communication method used by the second communication module 20b to communicate.

The user information management module 20c manages information (hereinafter referred to as user information) on the user who owns the edge device 10 (i.e., the user who uses the user terminal 20).

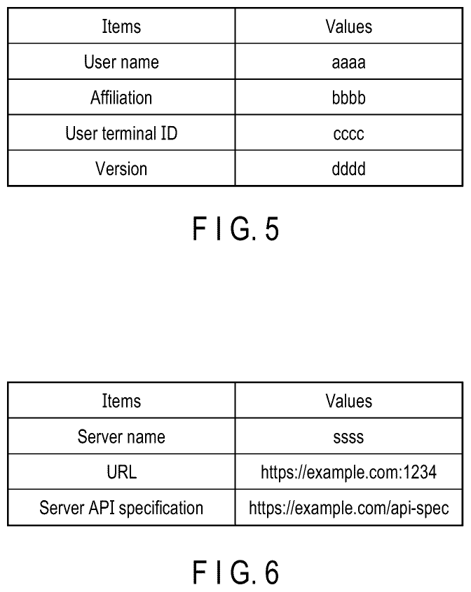

FIG. 5 shows an example of user information. As shown in FIG. 5, the user information includes, for example, the user's user name (user ID), the user's affiliation, the user terminal ID for identifying the user terminal 20, and the version of the user terminal 20.

The user name and the affiliation are, for example, information which is set by the user. The user terminal ID and the version are, for example, information that is embedded in advance at the time of manufacturing the user terminal 20 (in other words, information registered in advance in the user terminal 20).

Incidentally, in FIG. 5, it has been described that the user information includes the user name, affiliation, user terminal ID and version. In the user information, however, some elements of the information may be omitted or information other than these elements of information may be included.

The server information management module 20d manages information on the server device 40 (hereinafter referred to as server information).

FIG. 6 shows an example of server information. As shown in FIG. 6, the server information includes, for example, the server name of the server device 40, Uniform Resource Locator (URL) for accessing the server device 40, and the specifications of Application Programming Interface (API) implemented in the server device 40 (server API specifications).

The server name, the URL, and the server API specifications may be, for example, information set by the user, or information provided from the outside of the user terminal 20 (for example, server device 40 or the like).

Incidentally, in FIG. 6, it has been described that the server information includes the server name, the URL, and the server API specifications. In the server information, however, some elements of the information may be omitted or information other than these elements of information may be included.

The attestation nonce acquisition module 20e requests the certificate authority 30 to issue an attestation nonce via the second communication module 20b, and acquires (receives) the attestation nonce sent from the certificate authority 30 in response to the request. The attestation nonce acquired by the attestation nonce acquisition module 20e is delivered from the attestation nonce acquisition module 20e to the initial setting processing module 20f.

The initial setting processing module 20f executes processing on the initial settings of the edge device 10. More specifically, the initial setting processing module 20f instructs the edge device 10 to generate a certificate signing request when the user terminal 20 is connected to the edge device 10. In this case, the initial setting processing module 20f provides (sends) the attestation nonce delivered from the attestation nonce acquisition module 20e to the edge device 10 via the first communication module 20a. In addition, the initial setting processing module 20f provides the edge device 10 with (parts of) the above-mentioned user information and server information as information to be set in the edge device 10 (hereinafter referred to as setting information), in a series of the initial settings of the edge devices 10.

In addition, the initial setting processing module 20f acquires (receives) the certificate signing request sent from the edge device 10 via the first communication module 20a. The initial setting processing module 20f verifies the acquired certificate signing request.

If the verification of the certificate signing request executed by the initial setting processing module 20f is successful, the certificate acquisition module 20g transfers (sends) the certificate signing request to the certificate authority 30 via the second communication module 20b. In addition, the certificate acquisition module 20g acquires (receives) the public key certificate of the edge device 10, which is issued by the certificate authority 30 in response to the certificate signing request, via the second communication module 20b.

The public key certificate thus acquired by the certificate acquisition module 20g is delivered to the initial setting processing module 20f and is transferred (sent) to the edge device 10 via the first communication module 20a.

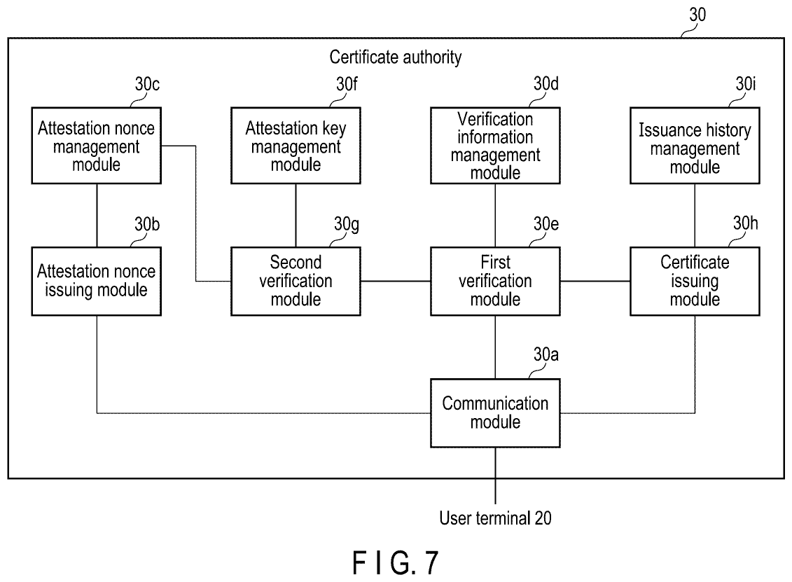

FIG. 7 shows an example of a functional configuration of the certificate authority 30 shown in FIG. 1. As shown in FIG. 7, the certificate authority 30 includes a communication module 30a, an attestation nonce issuing module 30b, an attestation nonce management module 30c, a verification information management module 30d, a first verification module 30e, an attestation key management module 30f, a second verification module 30g, a certificate issuing module 30h, and an issuance history management module 30l.

The communication module 30a executes communication with the user terminal 20 via the network 51. The attestation nonce issuing module 30b accepts a request (i.e., an attestation nonce issuance request) from the user terminal 20 via the communication module 30a and issues (generates) an attestation nonce. Incidentally, the attestation nonce issuing module 30b issues an attestation nonce with a value which is different for each user terminal 20 (i.e., the user using the user terminal 20) who is the source of the attestation nonce issuing request.

The attestation nonce issued by the attestation nonce issuing module 30b is provided (sent) to the user terminal 20 via the communication module 30a, and is also delivered to the attestation nonce management module 30c.

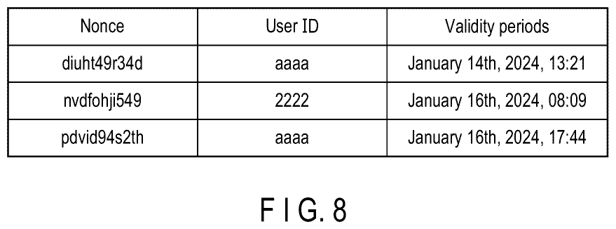

The attestation nonce management module 30c manages the attestation nonce delivered from the attestation nonce issuing module 30b. Incidentally, as shown in FIG. 8, the attestation nonce management module 30c further manages the user ID for identifying the user who is the destination of issuance of the attestation nonce (i.e., the requesting source) and a validity period of the attestation nonce (i.e., a deadline by which the attestation nonce is valid in the verification process to be described below), in addition to (the value of) the attestation nonce. Entries whose validity period has expired may be discarded at predetermined timing or may be updated to entries including a new validity period.

The verification information management module 30d manages information (hereinafter referred to as verification information) used to verify the certificate signing request sent from the user terminal 20. The verification information includes, for example, information on the user's possession device which can issue the public key certificate.

The first verification module 30e acquires (receives) the certificate signing request sent from the user terminal 20 via the communication module 30a, and then verifies the certificate signing request using the verification information managed by the verification information management module 30d. In addition, the first verification module 30e delivers the acquired certificate signing request to the second verification module 30g.

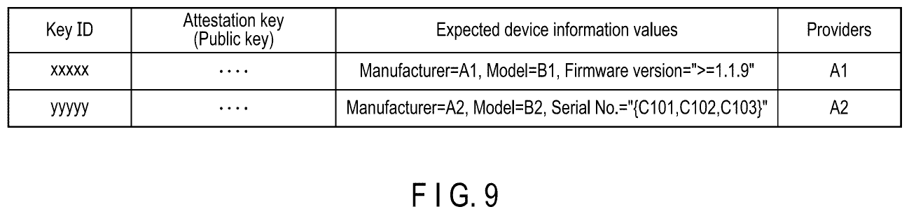

The attestation key management module 30f manages the above-described attestation key (in particular, the public key for the attestation). Incidentally, as shown in FIG. 9, the attestation key management module 30f further manages a key ID (attestation key ID) for identifying the attestation key and an expected device information value, in addition to the attestation key. The expected device information value corresponds to the range and conditional expressions of values expected as device information for the edge device 10 which manages (holds) the attestation key. In addition, the attestation key management module 30f may further manage the source of the information managed by the attestation key management module 30f (i.e., the ID or the like indicating the entity that has provided the attestation key and the expected device information value).

The information managed by the attestation key management module 30f is assumed to be provided by the manufacturer of the edge device 10 prior to shipment of the edge device 10. Incidentally, the certificate authority 30 may adopt a system which charges the manufacturer of the edge device 10 when accepting the information managed by the attestation key management module 30f from the manufacturer of the edge device 10 (i.e., when registering the information in the attestation key management module 30f).

The second verification module 30g verifies the attestation signature, device information, and the like included in the certificate signing request delivered from the first verification module 30e. In this case, the second verification module 30g refers to the information managed by the attestation nonce management module 30c and the attestation key management module 30f.

The certificate issuing module 30h issues a public key certificate in accordance with the results of the verification executed by the first and second verification modules 30e and 30g. The public key certificate issued by the certificate issuing module 30h is sent from the communication module 30a to the user terminal 20.

The issuance history management module 30l manages information on public key certificates issued in the past by the certificate issuing module 30h (hereinafter referred to as issuance history information). Whether or not the above-mentioned public key certificate need to be issued may be determined based on the issuance history information managed by the issuance history management module 30i (i.e., the history of the public key certificates issued in the past).

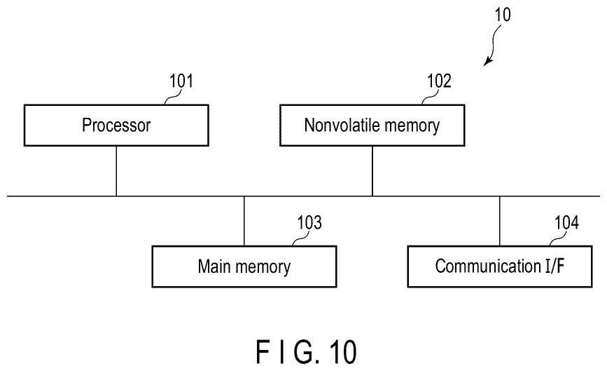

FIG. 10 shows an example of the hardware configuration of the above-described edge device 10. As shown in FIG. 10, the edge device 10 includes a processor 101, a nonvolatile memory 102, a main memory 103, a communication interface (I/F) 104, and the like.

The processor 101 is configured to control the operation of each component in the edge device 10 and may be, for example, a CPU or the like. In addition, the processor 101 may be a single processor or may be composed of multiple processors. The processor 101 runs various programs loaded from the nonvolatile memory 102 to the main memory 103. The communication interface 104 is, for example, an interface for enabling communication with the user terminal 20 and the server device 40.

In the embodiment, some or all of the modules 10a to 10i shown in FIG. 2 may be realized by causing the processor 101 shown in FIG. 10 to run a predetermined program (application program) (i.e., software), by hardware such as an integrated circuit (IC), or by a configuration obtained by combining software and hardware.

The hardware configuration of the edge device 10 has been described, but it is assumed that the user terminal 20 and the certificate authority 30 also have substantially the same hardware configuration.

In this case, some or all of the modules 20a to 20g shown in FIG. 4 may be realized by causing the processor (CPU) of the user terminal 20 to run a predetermined program (i.e., software) or may be implemented by hardware, or may be realized by a configuration obtained by combining software and hardware.

In addition, some or all of the modules 30a to 30i shown in FIG. 7 may be realized by causing the processor (CPU) of the certificate authority 30 to run a predetermined program (i.e., software) or may be implemented by hardware, or may be realized by a configuration obtained by combining software and hardware.

Incidentally, in the embodiment, it is assumed that the user terminal 20 further includes an input device, a display device, and the like to realize the above-described user interface.

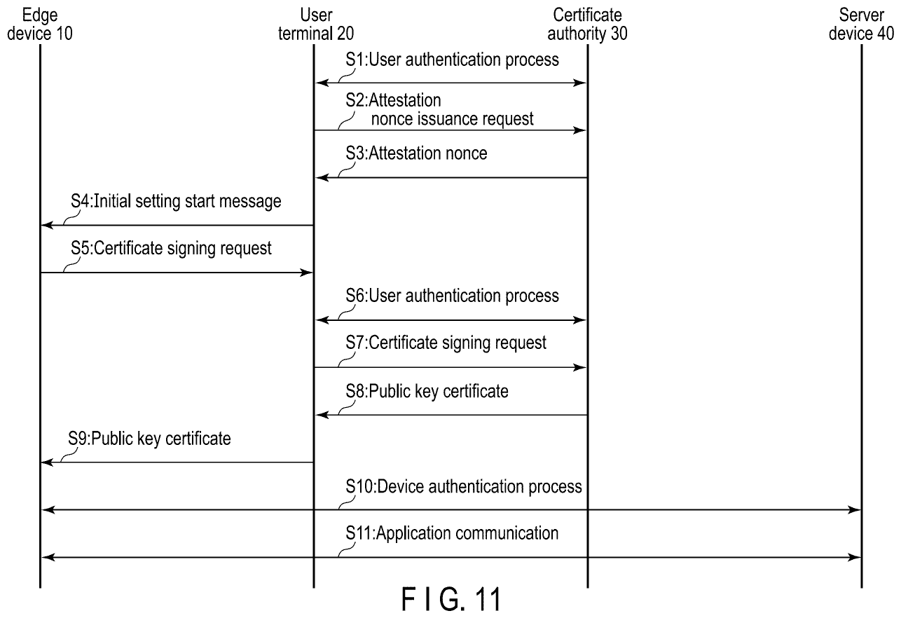

An example of the procedure of the communication system 1 according to the embodiment will be described below with reference to a sequence chart of FIG. 11.

Incidentally, in the embodiment, it is assumed that the edge device 10 is in the factory default state, and that at least a public key certificate used for the edge device 10 to communicate with the server device 40 is not registered in the edge device 10. The communication system 1 according to the embodiment operates to realize issuance and registration of the public key certificate of the above-described edge device 10 using the user terminal 20.

First, the user terminal 20 (for example, the attestation nonce acquisition module 20e) executes a user authentication process with the certificate authority 30 (step S1). Incidentally, the user authentication process corresponds to, for example, a process of sending the user ID, password, and the like for identifying the user using the user terminal 20 from the user terminal 20 to the certificate authority 30, and confirming in the certificate authority 30 whether or not the user is a legitimate user who can request the issuance of the public key certificate. It has been described that the user ID and the password are used in the user authentication process. However, the user authentication process may be a process of authenticating the user (or the user terminal 20) or the other information may be used.

If the user is authenticated by executing the process in step S1 (i.e., if it is confirmed that the user using the user terminal 20 is a legitimate user in the user authentication process), the attestation nonce acquisition module 20e included in the user terminal 20 requests the certificate authority 30 to issue the component certificate nonce via the second communication module 20b. In this case, the attestation nonce issuance request is sent from the second communication module 20b to the certificate authority 30 (step S2). Incidentally, the attestation nonce issuance request includes, for example, a user ID and the like for identifying the user who is the source of the request for the attestation nonce issuance request (i.e., the user using the user terminal 20 which has sent the attestation nonce issuance request).

The attestation nonce issuing module 30b included in the certificate authority 30 accepts the attestation nonce issuance request sent in step S2 via the communication module 30a. The attestation nonce issuing module 30b issues the attestation nonce in response to the accepted attestation nonce issuance request. The attestation nonce issued by the attestation nonce issuing module 30b is sent from the communication module 30a to the user terminal 20 (step S3). Incidentally, the attestation nonce management module 30c manages the attestation nonce issued by the attestation nonce issuing module 30b together with the user ID included in the attestation nonce issuance request and the validity period set for the attestation nonce. In this case, the time can be set to the time after a specified period of time has elapsed from the time when the attestation nonce is issued (for example, one minute later), as the validity period.

Next, for example, when the power of the edge device 10 in the factory default state is turned on, the edge device 10 becomes a state of waiting for initial settings, and it is assumed that the edge device 10 and the user terminal 20 are connected communicably with each other in response to the user's operation on the user terminal 20. When the user terminal 20 is thus connected to the edge device 10, a message requesting the start of initial settings of the edge device 10 (hereinafter referred to as initial setting start message) is sent from the first communication module 20a to the edge device 10 in accordance with the instructions from the initial setting processing module 20f included in the user terminal 20 (step S4). Incidentally, the user terminal 20 instructs the edge device 10 to generate the certificate signing request by executing the process in step S4.

The attestation nonce sent in step S3 is acquired by the attestation nonce acquisition module 20e via the second communication module 20b. The attestation nonce acquired by the attestation nonce acquisition module 20e is delivered from the attestation nonce acquisition module 20e to the initial setting processing module 20f. In this case, in the above-described step S4, the initial setting start message including the attestation nonce delivered from the attestation nonce acquisition module 20e to the initial setting processing module 20f is sent to the edge device 10.

In addition, when the initial setting start message is sent in step S4, for example, the setting information (information to be set in the edge device 10) acquired from the user information managed by the above-described user information management module 20c may be provided from the user terminal 20 to the edge device 10.

Furthermore, if the edge device 10 does not have a real-time clock, the initial setting start message may include the current time information provided by the user. According to this, the edge device 10 can set an internal clock in the edge device 10 based on the current time information included in the initial setting start message.

In addition, the initial setting start message may also include information specified by the user. The information specified by the user may include, for example, an identifier for identifying the user (user ID), a random character string for nonce purposes, and the like.

It has been described that the initial setting start message includes various types of information. However, such information may also be included in other messages following the initial setting start message.

When the process in step 4 is executed, the request generation module 10c contained in the edge device 10 acquires the initial setting start message sent in step S4 via the first communication module 10a.

The request generation module 10c generates a certificate signing request which requests the issuance of the public key certificate in response to the acquired initial setting start message (i.e., the instruction to generate a certificate signing request). The certificate signing request generated by the request generation module 10c is, for example, a Certificate Signing Request (CSR) conforming to PKCS #10 (RFC2986) of the Public-Key Cryptography Standards (PKCS).

Incidentally, the certificate signing request includes the public key of the edge device 10, which is managed by the first key management module 10e. In addition, the certificate signing request includes the device information managed by the device information management module 10d, and the attestation nonce included in the initial setting start message.

In addition, the signature generation module 10h acquires the attestation key from the second key management module 10g and generates an attestation signature for the above-described device information and attestation nonce. The attestation signature corresponds to an electronic signature using the attestation key for the device information and attestation nonce. The attestation signature is generated by, for example, executing a cryptographic process using the attestation key (attestation private key) on the hash value of the device information and attestation nonce.

As described above, the attestation signature generated by the signature generation module 10h is used to guarantee the authenticity of the device information included in the certificate signing request, and is delivered from the signature generation module 10h to the request generation module 10c. Incidentally, the signature generation module 10h delivers the attestation key ID acquired from the second key management module 10g to the request generation module 10c, together with the attestation signature.

According to this, the request generator 10c generates the certificate signing request including the attestation signature and attestation key ID together with the above-described public key, device information, and attestation nonce.

The certificate signing request thus generated by the request generator 10c is sent from the first communication module 10a to the user terminal 20 (step S5).

Incidentally, the certificate signing request may also include some of the various information included in the above-described initial setting start message (for example, the user information provided by the user terminal 20) and the date and time when the certificate signing request is generated, or the like. According to this, it is possible to determine the user who has instructed the generation of the certificate signing request and the date and time when the certificate signing request is generated (i.e., the date and time when the initial settings of the edge device 10 are started), by referring to (the information included in) the certificate signing request.

When the process in step S5 is executed, the initial setting processing module 20f included in the user terminal 20 acquires the certificate signing request sent in step S5 via the first communication module 20a.

The initial setting processing module 20f verifies the acquired certificate signing request. In this case, for example, the verification of the certificate signing request is successful if the user information provided by the user terminal 20 is included in the certificate signing request, and fails if the user information is not included in the certificate signing request. Incidentally, the verification of the certificate signing request may be executed based on the other information.

The initial setting processing module 20f delivers the certificate signing request to the certificate acquisition module 20g if the verification of the certificate signing request is successful, and discards the certificate signing request if the verification of the certificate signing request fails. Incidentally, if the certificate signing request is discarded, the initial setting processing module 20f may notify the user of the error.

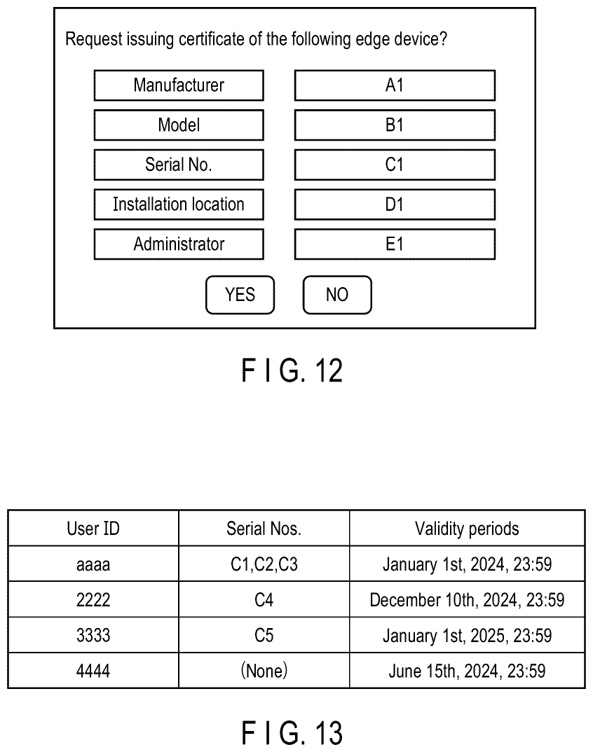

Incidentally, the verification of the certificate signing request may be executed by the user confirming the contents of the certificate signing request. In this case, for example, the user terminal 20 is assumed to present the device information included in the certificate signing request to the user on a screen as shown in FIG. 12 (hereinafter referred to as a device confirmation screen). According to this, the user can confirm whether or not the certificate signing request acquired (received) by the user terminal 20 is a certificate signing request generated by the edge device 10 which the user intends.

More specifically, for example, when the device information presented on the device confirmation screen matches the device information (serial number and the like) printed on the housing of the edge device 10, the user instructs requesting the issuance of a public key certificate based on the certificate signing request acquired at the user terminal 20 (i.e., executing the processes subsequent to step S6).

If the verification of the above-described certificate signing request is successful, the certificate acquisition module 20g executes the user authentication process with the certificate authority 30 (step S6). Since the process in step S6 is the same as the above-described process in step S1, its detailed descriptions are omitted here.

Incidentally, the user authentication process is executed in step S1 as described above. Therefore, if the authentication session information (information indicating that the user has already been authenticated) is held in the user terminal 20 or the certificate authority 30 by executing the user authentication process in step S1, the process in step S6 may be omitted.

Next, the certificate acquisition module 20g transfers the certificate signing request acquired by the initial setting processing module 20f to the certificate authority 30 via the second communication module 20b (step 7).

When the process in step S7 is executed, the first verification module 30e included in the certificate authority 30 acquires the certificate signing request transferred from the user terminal 20 in step S7, via the communication module 30a.

The first verification module 30e executes the verification of the acquired certificate signing request, based on the verification information managed by the verification information management module 30d. If the edge device 10 which is the target of the certificate signing request (i.e., the edge device 10 which can request the issuance of the public key certificate) and the certificate attribute information is preset by, for example, the user, it may be confirmed whether or not the edge device 10 or the attribute information is appropriate, in the verification of the certificate signing request. In this case, the attribute information includes, for example, the location of the edge device 10, and the administrator's information, and the like.

Incidentally, the verification of the certificate signing request may be executed by confirming whether or not the data structure of the certificate signing request and the information included in the certificate signing request conform to the specifications required by the certificate authority 30.

An example of a process (hereinafter referred to as a first verification process) related to the verification of the certificate signing request executed by the first verification module 30e as described above will be described below.

First, FIG. 13 shows an example of the verification information. In the example shown in FIG. 13, the verification information includes the user ID for identifying the user, the serial number of the edge device 10 owned by the user, and the validity period of the verification information in association with each other. The verification information (entries) that have expired may be discarded at predetermined timing or may be updated to entries including a new validity period.

It is assumed here that the certificate signing request acquired by the first verification module 30e includes the user information (for example, user ID) and the device information (for example, serial number). The verification of the certificate signing request is successful if both the user ID and the serial number match (i.e., there is the verification information which includes the user ID and the serial number included in the certificate signing request in association with each other) as a result of comparing the certificate signing request with the verification information. In addition, the verification of the certificate signing request fails if at least one of the user ID and the serial number does not match (i.e., there is no verification information which includes the user ID and the serial number included in the certificate signing request in association with each other) as a result of comparing the certificate signing request with the verification information.

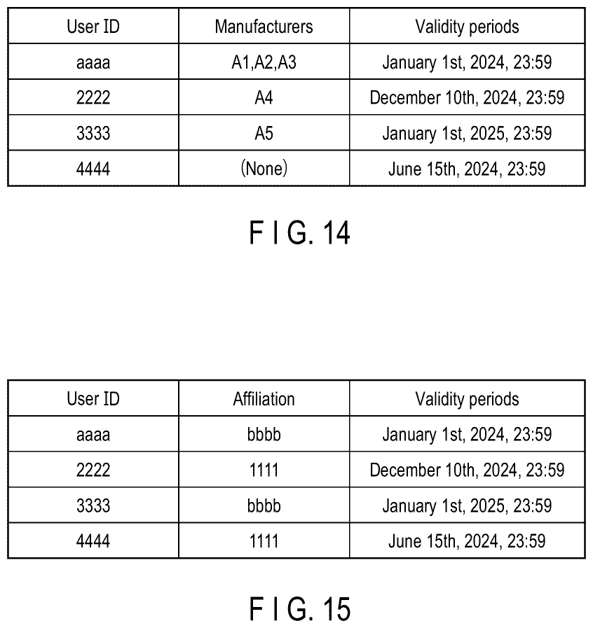

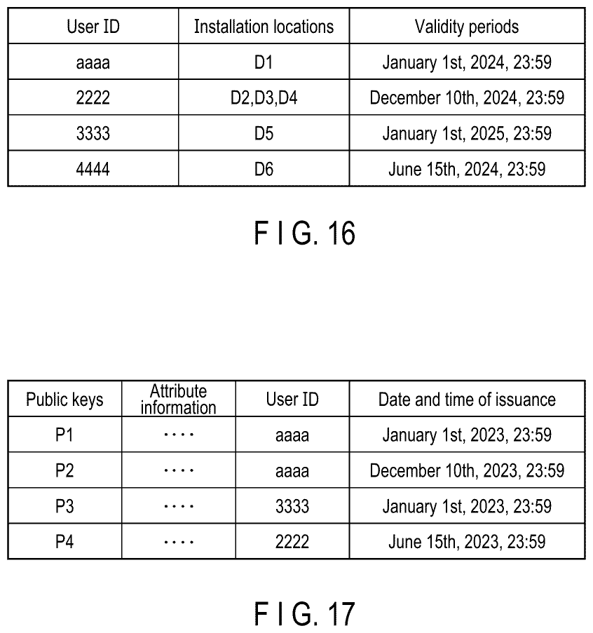

It has been described that the verification information is the information including the user ID and the serial number in association with each other. For example, however, the verification information may also be the information including the user ID and the manufacturer of the edge device 10 in association with each other as shown in FIG. 14, the information including the user ID and the user's affiliation in association with each other as shown in FIG. 15, or the information including the user ID and the installation location of the edge device 10 in association with each other as shown in FIG. 16. Even in the case of the verification information as shown in FIG. 14 to FIG. 16, the first verification process can be executed by comparing the certificate signing request with the verification information.

Incidentally, the verification information managed by the verification information management module 30d may be information having a structure obtained by combining FIG. 13 to FIG. 16.

In other words, in the embodiment, it is considered that the edge device 10 which can issue the public key certificate according to the authority preset for the user (user terminal 20) is limited or specified, by the above-described verification information.

Incidentally, in the above-described first verification process, the verification of the certificate signing request is executed by comparing the certificate signing request with the verification information. If the authenticity of the device information (for example, the serial number and the like) included in the certificate signing request cannot be confirmed (i.e., if the certificate signing request includes false device information), a public key certificate may be issued for a device for which the public key certificate originally should not be issued.

For this reason, in the embodiment, the second verification module 30g executes the second verification process separately from the above-described first verification process. Incidentally, the second verification process may be executed before or after the first verification process or may be executed in parallel with the first verification process.

An example of the second verification process will be described below. In the second verification process, the verification of the attestation signature, the device information, and the attestation nonce is executed.

Incidentally, when the second verification process is executed, the certificate signing request and the user ID (i.e., the user ID for identifying the user using the user terminal 20 which has transferred the certificate signing request to the certificate authority 30) are delivered from the first verification module 30e to the second verification module 30g.

First, the verification of the attestation signature will be described. If it is assumed that the information shown in FIG. 9 is managed by the attestation key management module 30f, the second verification module 30g acquires the attestation key (public key for attestation) associated with the attestation key ID from the attestation key management module 30f, by using the attestation key ID included in the certificate signing request delivered from the first verification module 30e. The second verification module 30g verifies the attestation signature included in the certificate signing request, by using the attestation key thus obtained. More specifically, a process of calculating the device information included in the certificate signing request and the hash value of the attestation nonce, and collating the calculated hash values with the result (hash value) obtained by encrypting the attestation signature included in the certificate signing request with the public key for the attestation, is executed. In this case, if the hash values of the device information and the attestation nonce match the hash value obtained from the attestation signature, it can be confirmed that the attestation signature has been successfully verified.

Next, the verification of the device information will be described. If it is assumed that the information shown in FIG. 9 is managed by the attestation key management module 30f as described above, the second verification module 30g acquires the expected device information value associated with the attestation key ID from the attestation key management module 30f, by using the attestation key ID included in the certificate signing request delivered from the first verification module 30e. The second verification module 30g collates the device information included in the certificate signing request with the expected device information value acquired from the attestation key management module 30f, and verifies whether or not the device information satisfies the expected device information value. More specifically, as shown in FIG. 9, if the attestation key ID is assumed to be “xxxx”, in a case where the manufacturer of the device information included in the certificate signing request is “A1”, the model is “B1”, and the firmware version is “1.1.9 or later”, it can be confirmed that the device information verification is successful. In addition, as shown in FIG. 9, if the attestation key ID is “yyyy”, in a case where the manufacturer of the device information included in the certificate signing request is “A2”, the model is “B2”, and the serial number is “C101”, “C102”, or “C103”, it can be confirmed that the device information verification is successful.

Next, the verification of the attestation nonce will be described. If it is assumed that the information shown in FIG. 8 is managed by the attestation key management module 30f as described above, the second verification module 30g acquires the validity period associated with (the value of) the attestation nonce from the attestation nonce management module 30c, by using the attestation nonce included in the certificate signing request delivered from the first verification module 30e. According to this, the second verification module 30g can confirm that the verification of the attestation nonce is successful if the validity period acquired from the attestation nonce management module 30c has not expired (i.e., the attestation nonce is still within its validity period). Incidentally, in the verification of the attestation nonce, the user ID associated with (the value of) the attestation nonce included in the certificate signing request delivered from the first verification module 30e may be acquired from the attestation nonce management module 30c, and it may be verified whether or not the acquired user ID matches the user ID delivered from the first verification module 30e.

If at least one of the verifications of the attestation signature, device information, and attestation nonce fails (i.e., an error occurs during the verification process), as described above, the second verification module 30g notifies the first verification module 30e of the error.

The first verification module 30e delivers the certificate signing request to the certificate issuing module 30h if the verification in the above-described first and second verification processes is successful, and discards the certificate signing request if the verification in the first or second verification process fails. Incidentally, if the certificate signing request is discarded, the first verification module 30e may notify (the user using) the user terminal 20 of the error via the communication module 30a.

If the verifications in the first and second verification processes are successful, the certificate issuing module 30h takes over the process from the first verification module 30e and issues a public key certificate for the edge device 10 in response to the certificate signing request delivered from the first verification module 30e. When a public key certificate is thus issued by the certificate issuing module 30h, the issuance history information for the issued public key certificate is managed by the issuance history management module 30i. In addition, the public key certificate for the edge device 10 thus issued by the certificate issuing module 30h is sent from the communication module 30a to the user terminal 20 (step S8).

Incidentally, it has been described that a public key certificate is issued when the verifications in the first and second verification processes are successful. However, the certificate issuing module 30h may issue a public key certificate based on the issuance history information managed by the issuance history management module 30i (i.e., the history of the public key certificates issued in the past).

FIG. 17 shows an example of the issuance history information. As shown in FIG. 17, the issuance history information includes the public keys for which the public key certificates have been issued in the past, attribute information for the public key certificates, the user ID for identifying the users who have requested the issuance of the public key certificates, and the date and time (issuance date and time) when the public key certificates were issued. Incidentally, the attribute information includes, for example, information such as the identifier, the installation location and the like of the edge device 10.

According to the issuance history information shown in FIG. 17, the certificate issuing module 30h can confirm whether or not a certificate for the same public key as the public key for which the issuance of the public key certificate is requested by the certificate signing request has been issued in the past (in other words, whether or not the issuance history information including the same public key and attribute information as the certificate signing request, is already managed by the issuance history management module 30i), by referring to the issuance history information. More specifically, for example, if the certificate signing request includes the date and time when the certificate signing request was generated (hereinafter referred to as request generation date and time), in a case where the public key and the attribute information included in the issuance history information including the issuance date and time before the request generation date and time, match the public key and the attribute information included in the certificate signing request, it can be confirmed that the certificate for the same public key has been issued in the past.

If it is confirmed that the certificate for the same public key has been issued in the past, the certificate issuing module 30h may not issue a public key certificate in response to the certificate signing request, but may discard the certificate signing request. In this case, the certificate issuing module 30h may notify (the user using) the user terminal 20 via the communication module 30a that the certificate signing request has been discarded or may notify the administrator of the certificate authority 30 of the alert.

In this case, it has been described that a public key certificate is not issued if the certificate for the same public key has already been issued. For example, however, a public key certificate for the same public key can be re-issued by embedding the serial number of the public key certificate or a random number in the attribute information (in other words, making the attribute information different by the serial number or random number).

When the process in step S8 is executed, the certificate acquisition module 20g included in the user terminal 20 acquires the public key certificate sent in step S8 via the second communication module 20b. The public key certificate acquired by the certificate acquisition module 20g is delivered to the initial setting processing module 20f and is sent from the first communication module 20a to the edge device 10 (step S9).

When the process in step S9 is executed, the registration module 10f included in the edge device 10 acquires the public key certificate sent in step S9 via the first communication module 10a. The public key certificate acquired by the registration module 10f is registered (set) in the edge device 10. The initial settings of the edge device 10 are thereby completed.

Incidentally, in step S9, the setting information for the edge device 10 to execute communication with the server device 40 (for example, server information managed by the server information management module 20d) may be sent together with the public key certificate, and the setting information may be registered in the edge device 10.

When the public key certificate is registered in the edge device 10 as described above, the device authentication process using the public key certificate is executed between the edge device 10 and the server device 40 (step S10). Incidentally, in step S10, for example, the device authentication process for confirming whether the public key certificate presented by the edge device 10 is a public key certificate legitimately issued for the public key of the edge device 10 may be executed.

If the edge device 10 is authenticated by the execution of the process in step S10, the application processing part 10i included in the edge device 10 starts execution of the application communication with the server device 40 (step S11). Providing the IoT services is achieved by the edge device 10 and the server device 40 operating in cooperation as an application system via such application communication.

Incidentally, in FIG. 11, although detailed descriptions are omitted, for example, the first key management module 10e included in the edge device 10 may generate an electronic signature attached to the certificate signing request, using the private key of the edge device 10 managed by the first key management module 10e. Incidentally, the electronic signature is generated by, for example, executing a cryptographic process using the private key of the edge device 10 on the hash value of the certificate signing request.

In this case, the certificate signing request with the electronic signature is sent from the edge device 10 to the user terminal 20, and the initial setting processing part 20f included in the user terminal 20 can execute verification of the certificate signing request using the electronic signature. In verifying such a certificate signing request, a process of calculating the hash value of the certificate signing request, and collating the calculated hash value with the result (hash value) of the cryptographic processing of the electronic signature attached to the certificate signing request using the public key (i.e., the public key of the edge device 10) paired with the private key of the edge device 10, is executed. The verification of the certificate signing request is successful if the hash value of the certificate signing request matches the hash value obtained from the electronic signature.

It has been described that the electronic signature generated at the edge device 10 is attached to the certificate signing request sent from the edge device 10 to the user terminal 20. However, the electronic signature generated using the private key of the user terminal 20 may be attached to the certificate signing request sent from the user terminal 20 to the certificate authority 30. In this case, the first verification module 30e included in the certificate authority 30 can verify the certificate signing request using the electronic signature attached to the certificate signing request sent from the user terminal 20 and the public key of the user terminal 20. According to this, it can be confirmed that the edge device 10 generates the certificate signing request in accordance with the instructions of the user terminal 20.

In addition, the electronic signature generated using the private key of the certificate authority 30 may be attached to the public key certificate sent from the certificate authority 30 to the user terminal 20. In this case, the certificate acquisition module 20g included in the user terminal 20 can verify the public key certificate using the electronic signature attached to the public key certificate sent from the certificate authority 30 and the public key of the certificate authority 30. Incidentally, for example, the verification of the public key certificate verification may be executed by the registration module 10f included in the edge device 10.

Incidentally, the processing shown in FIG. 11 is one example, and processing partially different from the processing described with reference to FIG. 11 may be executed or processing obtained by omitting some parts of the processing described with reference to FIG. 11 may be executed in the embodiment. More specifically, in the embodiment, it has been described that, for example, the first and second verification processes are executed. However, the first and second verification processes may be partially changed or omitted or verification processes different from the first and second verification processes may be further executed.

As described above, in the embodiment, the edge device 10 (communication device) sends to the user terminal 20 (terminal device) the certificate signing request which requests the issuance of the certificate used for the edge device 10 to communicate with the server device 40, and which includes the attestation signature (electronic signature) generated using the device information on the edge device 10, the attestation nonce, and the attestation key (private key for the attestation) held in advance in the edge device 10 for the device information and the attestation nonce. In addition, in the embodiment, the user terminal 20 sends (transfers) the certificate signing request sent from the edge device 10 to the certificate authority 30. In this case, the certificate authority 30 verifies the attestation signature included in the certificate signing request sent from the user terminal 20, and issues the public key certificate in accordance with the verification results, by using the public key for the attestation.

In the embodiment, with the above-described configuration, the public key certificate for the edge device 10 in the factory default state (i.e., the public key certificate used by the edge device 10 for communication) can easily be issued.

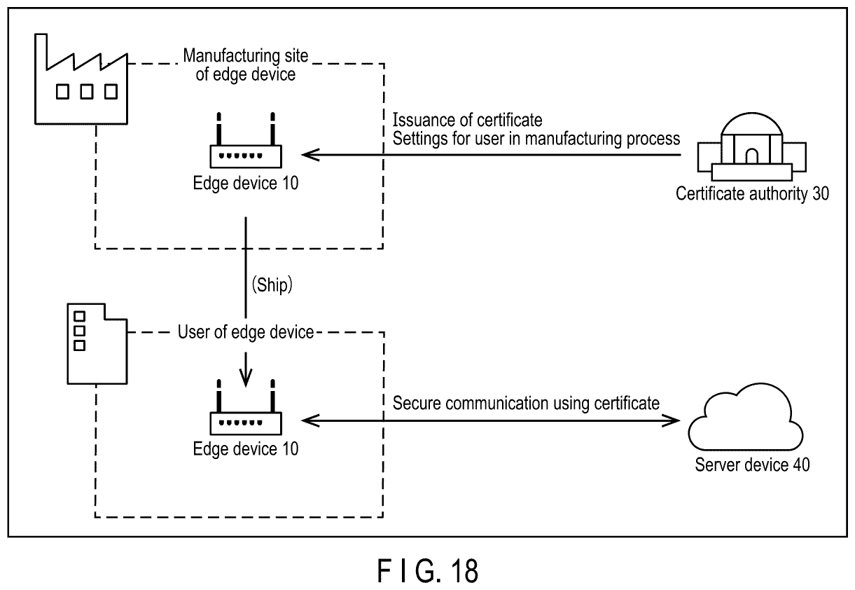

FIG. 18 shows an overview of issuance of a public key certificate in the first comparative example of the embodiment. As shown in FIG. 18, in the first comparative example of the embodiment, the settings for user such as registration of the public key certificate issued by the certificate authority 30 at the manufacturing site of the edge device 10 is completed, and the user can execute communication (secure communication using the certificate) with the server device 40 using the edge device 10 having the public key certificate already registered.

However, in the above-described first comparative example, since the public key certificate is registered in advance in the edge device 10 before shipment from the factory, for example, issuance of the public key certificate cannot be executed at the certificate authority 30 specified by the user. Furthermore, if the public key certificate is issued and registered in advance, it takes much time before the edge device 10 is shipped.

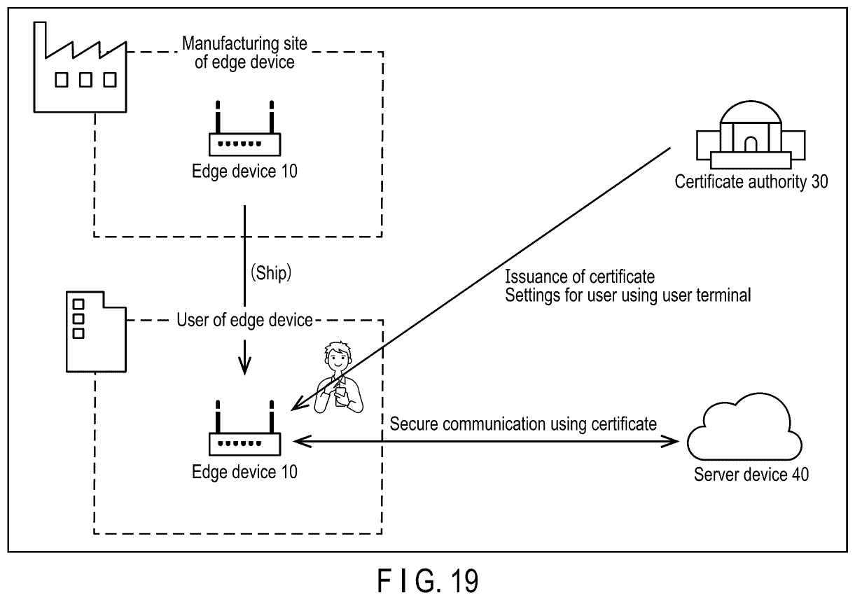

In contrast, FIG. 19 shows an overview of the issuance of the public key certificate in the embodiment. As shown in FIG. 19, in the embodiment, the public key certificate of the edge device 10 in the factory default state is issued and registered using the user terminal 20 after the edge device 10 for which the public key certificate is not issued or registered in advance is shipped from the factory.

According to such a configuration, unlike the above-described first comparative example of the embodiment, for example, if the information as shown in FIG. 9 is registered in advance in the certificate authority 30, the certificate authority 30 specified by the user who owns the edge device 10 (i.e., the user who uses the user terminal 20) to issue and register the public key certificate can be used.

Furthermore, in the embodiment, settings to connect the edge device 10 to connect to the certificate authority 30 in relation to issuance of the public key certificate are unnecessary, and it is possible to automate issuance and registration (i.e., initial settings) of public key certificate for the edge device 10 in the factory default state. In other words, in the embodiment, since specialist knowledge or complicated work related to the issuance and registration of the public key certificate, and the like is unnecessary, it is possible to reduce the user's labor (i.e., to easily execute initial settings including the issuance and registration of the public key certificate).

In addition, in the embodiment, since the settings for user such as the issuance and registration of the public key certificate do not need to be completed before shipment from the factory, it can contribute to the rapid shipment of the edge device 10.

Incidentally, in the embodiment, the issuance of the public key certificate from the certificate authority 30 using the user terminal 20 can be executed in the configuration that the user terminal 20 instructs the edge device 10 to generate the certificate signing request and the edge device 10 generates the certificate signing request in response to the instruction from the user terminal 20 when the edge device 10 and the user terminal 20 are connected communicably with each other.

Furthermore, in the embodiment, the settings of the edge device 10 can be executed based on the information provided from the user terminal 20 in the configuration that the user terminal 20 sends user information on the user who owns the edge device 10 (i.e., the user who uses the user terminal 20) and the server information on the server device 40 to the edge device 10 and that the user information and the server information sent from the user terminal 20 is set in the edge device 10. Incidentally, in the embodiment, the user may also specify the server device 40 (cloud system) with which the edge device 10 cooperates, or the like, in addition to the above-described certificate authority 30.

In addition, the certificate authority 30 of the embodiment executes, for example, the verification of the certificate signing request based on the device information included in the certificate signing request in the first verification process, and issues the public key certificate if the verification of the certificate signing request is successful. According to such a configuration, a public key certificate for a legitimate edge device 10 can be issued.

Furthermore, the embodiment adopts the configuration of verifying the authenticity of the device information using the attestation signature in the second verification process. The advantages on security obtained by adopting such a configuration will be described below.

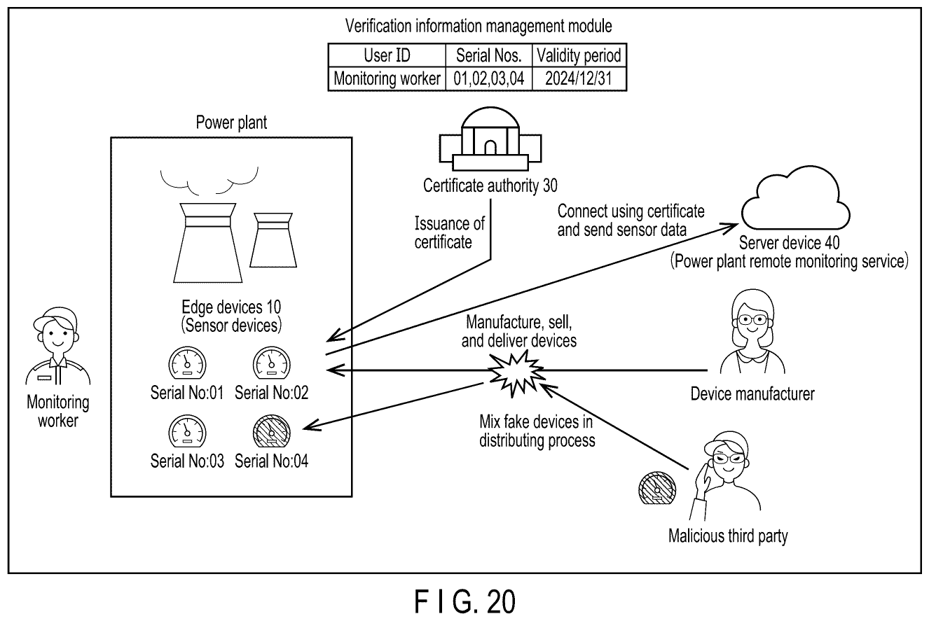

First, the security threats (security risks) in a case where the configuration of verifying the authenticity of the above-described device information is not adopted (hereinafter referred to as a second comparative example of the embodiment) will be described with reference to FIG. 20.

Incidentally, in the example shown in FIG. 20, for example, it is assumed that a large number of sensor devices installed in a power plant operate as edge devices 10 and that the sensor devices are connected to a power plant remote monitoring service built on a cloud service (i.e., execute communication with the server device 40 which provides the power plant remote monitoring service). The sensor devices are manufactured, sold, and delivered by the device manufacturer, and are configured to measure data (sensor data) related to the operating status of various devices installed in the power plant.

In the above-described second comparative example of the embodiment, a monitoring worker of the power plant can issue the public key certificate at the certificate authority 30 and register the public key certificate in each of the sensor devices, using the user terminal 20. The public key certificate is issued when the verification of the certificate signing request using the verification information managed by the verification information management module 30d included in the certificate authority 30 is successful.

Each sensor device uploads (sends) sensor data (measured data) to the power plant remote monitoring service, using the public key certificate registered in the sensor device. According to this, a power plant remote monitoring service of analyzing the sensor data uploaded from the sensor devices and constantly monitoring whether there are any abnormalities in the devices installed in the power plant can be realized. The power plant remote monitoring service issues an alarm to the monitoring worker and urges the monitoring worker to take action in response to the alarm (i.e., the abnormality) when an abnormality is detected.

Incidentally, as shown in FIG. 20, the verification information managed by the verification information management module 30d is registered in the verification information management module 30d (certificate authority 30) when the sensor devices which the monitoring worker has purchased from the device manufacturer are delivered. The verification information (entry) shown in FIG. 20 indicates that the owner of the sensor devices (four sensor devices with serial numbers “01” to “04”) delivered by the device manufacturer is the monitoring worker. According to the verification information, only the monitoring worker can issue the public key certificate to the sensor device using the user terminal 20 and use the remote power plant monitoring service.

It is assumed here that, as described above, a malicious third party (for example, a terrorist or the like) obtains an opportunity to get the sensor devices in a process of distributing the sensor devices from the device manufacturer to the monitoring worker as described above. In this case, it is considered that the malicious third party may prepare elaborate fake products, replace some or all of the multiple sensor devices manufactured by the device manufacturer with the fake products (hereafter referred to as fake devices), and deliver the fake devices to the monitoring worker. Incidentally, in FIG. 20, an example is shown in which the sensor device with serial number “04” (hereafter referred to as legitimate device) among the four sensor devices with serial numbers “01” to “04” is replaced with the fake device (i.e., the fake device is mixed).

Incidentally, it is assumed that the malicious third party reads the device information from the legitimate device and copies the device information to the fake device before delivering the fake device to the monitoring worker. In such cases, the fake device holds the same device information as the legitimate device. In the second comparative example of the embodiment, when the process on the initial settings is executed, the certificate authority 30 recognizes that the device has already been registered in the verification information management module 30d although the device is the fake device, and a public key certificate for the fake device is issued.

In this case, for example, the fake device uploads the sensor data (data related to the operation status of the device) measured by operating in the same manner as the legitimate device to the power plant remote monitoring service for a while. However, it is considered that when the device receives remote instructions from the malicious third party or when the time reaches a predetermined time, the false device is made to operate to upload the false data. If the false data is data which indicates an abnormality in the device installed in the power plant, the power plant remote monitoring service frequently issue alarms to the monitoring worker based on the false data, and the monitoring worker is made busy in responding to the alarms. According to this, confusion at the power plant may be caused and the operation of the power plant may be stopped consequently.

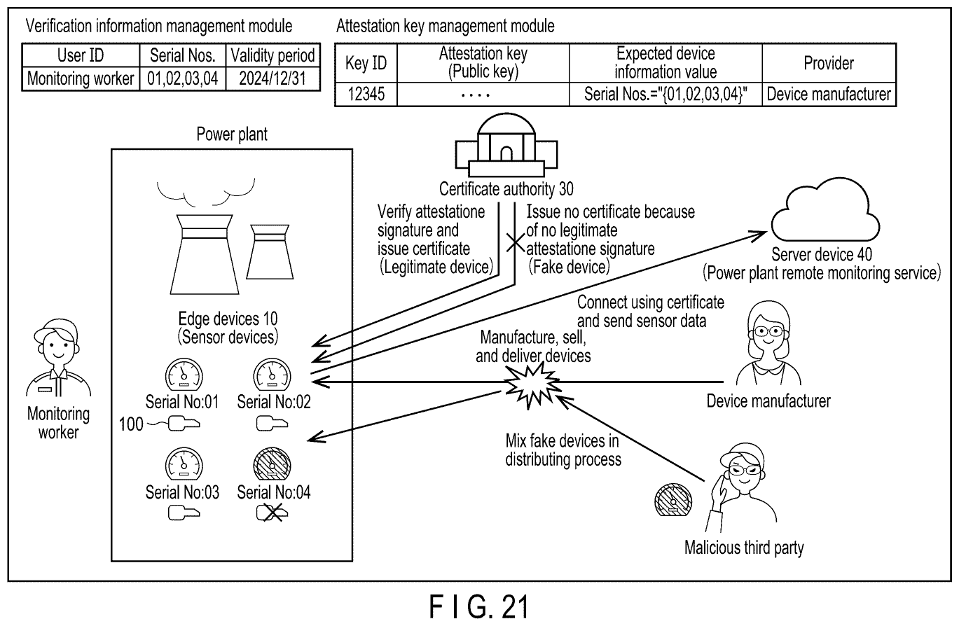

In contrast, as shown in FIG. 21, when adopting the configuration of verifying the authenticity of the device information as described in the embodiment, the device manufacturer generates an attestation key 100 upon manufacturing each sensor device, and registers the generated attestation key 100 in the second key management module 10g included in the sensor device. Incidentally, for example, the second key management module 10g is arranged in hardware referred to as a secure element and is configured such that data cannot be read or written from the outside after shipment. Furthermore, in the embodiment, the device manufacturer registers the attestation key (i.e., the public key for attestation) in the certificate authority 30 (attestation key management module 30f) and then sells and delivers the sensor device to the monitoring worker.

It is assumed here that as described in the above-described second comparative example of the embodiment, a malicious third party getting the sensor device (legitimate device) in the process of distributing the sensor device delivers to the monitoring worker a fake device manufactured by copying the legitimate device in terms of appearance, basic functions, device information, and the like. As described above, however, since the attestation key for the legitimate device is kept secret in the secure element, the malicious third party cannot copy the attestation key, and the fake device does not hold the attestation key.

According to this, in the embodiment, when the processing related to the initial settings is executed, a public key certificate is issued in response to the certificate signing request from the legitimate device by executing the verification of the above-described attestation signature, but it is possible to realize discarding the certificate signing request from the fake device (in other words, the public key certificate of the fake device is not issued for lack of the legitimate attestation signature).

As described above, according to the configuration of verifying the authenticity of the device information (i.e., executing the verification of the attestation signature) in the embodiment, it is possible to prevent fake devices prepared by malicious third parties such as terrorists from connecting to the power plant remote monitoring service (i.e., to avoid security threats).

Incidentally, the verification of the attestation signature executed in the second verification process has been described. In the second verification process, however, the verification of the device information and the verification of the attestation nonce are further executed. According to such a configuration, security risks in the IoT services can be further reduced.

In addition, in order to reduce the security risks, the verification of the certificate signing request executed in the first verification process may be executed using the electronic signature attached to the certificate signing request or the verification of the public key certificate issued by the certificate authority 30 may be executed using the electronic signature attached to the public key certificate (i.e., the electronic signature generated by the certificate authority 30).

In addition, in the embodiment, it is possible to issue a public key certificate in response to a request from a legitimate user by executing the user authentication process for the user who owns the edge device 10 between the user terminal 20 and the certificate authority 30. Incidentally, it has been described that the certificate authority 30 executes the user authentication process in the embodiment. For example, however, a device different from the certificate authority 30 (for example, the server device 40, the other server device different from the server device 40, or the like) may execute the user authentication process on behalf of the certificate authority 30.

In addition, in the embodiment, whether or not to issue the public key certificate may be determined based on the issuance history information on the public key certificates issued in the past. According to such a configuration, for example, it is possible to avoid a situation where the communication system 1 does not operate normally by issuing multiple certificates for the same public key. In addition, by using the above-described issuance history information, issuance errors of the public key certificates and replay attacks of sending the same certificate signing request to the certificate authority 30 multiple times may be prevented.

Furthermore, in the embodiment, as described above, when the edge device 10 is authenticated by executing the device authentication process for the edge device 10 using the public key certificate registered in the edge device 10, communication with the server device 40 is executed. It is therefore possible to provide the IoT services with reduced security risks.

Incidentally, the embodiment may be configured to enable the issuance of the public key certificate for the edge device 10 in the factory default state to be realized using user terminals 20. For example, the communication system 1, the edge device 10, the user terminal 20, and the certificate authority 30 described above in the embodiment may have some of their components omitted or other components may be added.

### Second Embodiment

Next, a second embodiment will be described. In the embodiment, detailed descriptions of the portions like or similar to the above-described first embodiment are omitted and the portions different from those of the first embodiment will be mainly described.

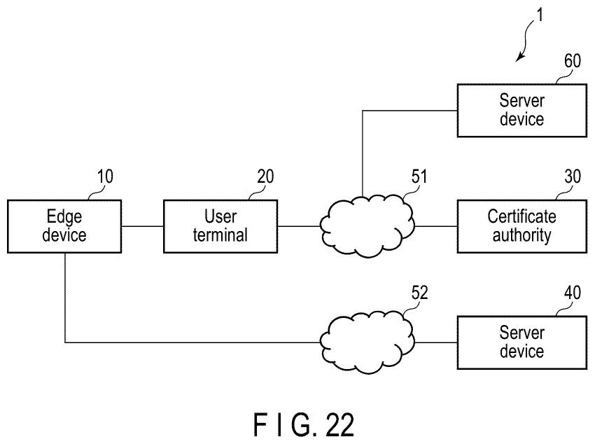

FIG. 22 shows an example of a system configuration of a communication system according to the embodiment. Incidentally, in FIG. 22, portions like or similar to those shown in FIG. 1 are denoted by the same reference numbers and symbols, and their detailed explanations are omitted.

As shown in FIG. 22, the communication system 1 of the embodiment further includes a server device 60 that is different from the server device 40 in comparison with the above-described first embodiment.

The server device 60 is connected communicably with the user terminal 20 via the network 51 and is configured to execute a process of verifying the authenticity of the device information described in the above-described first embodiment (i.e., the second verification process).

In other words, the embodiment is different from the above-described first embodiment in that the server device 60 executes the second verification process on behalf of the certificate authority 30. The server device 60 in the embodiment corresponds to an independent server device (verification server device) for executing the verification in the second verification process.

In the embodiment, the user terminal 20 executes the processing for the initial settings of the edge device 10 by executing communication with the edge device 10, the certificate authority 30, and the server device 60.

Incidentally, it has been described that the server device 60 is connected communicably with the user terminal 20 via the network 51. However, the server device 60 may be connected communicably with the user terminal 20 via a network different from the network 51.

In addition, the entity operating the server device 60 may be the same as or different from the certificate authority 30. More specifically, for example, the server device 60 may be operated by the device manufacturer.

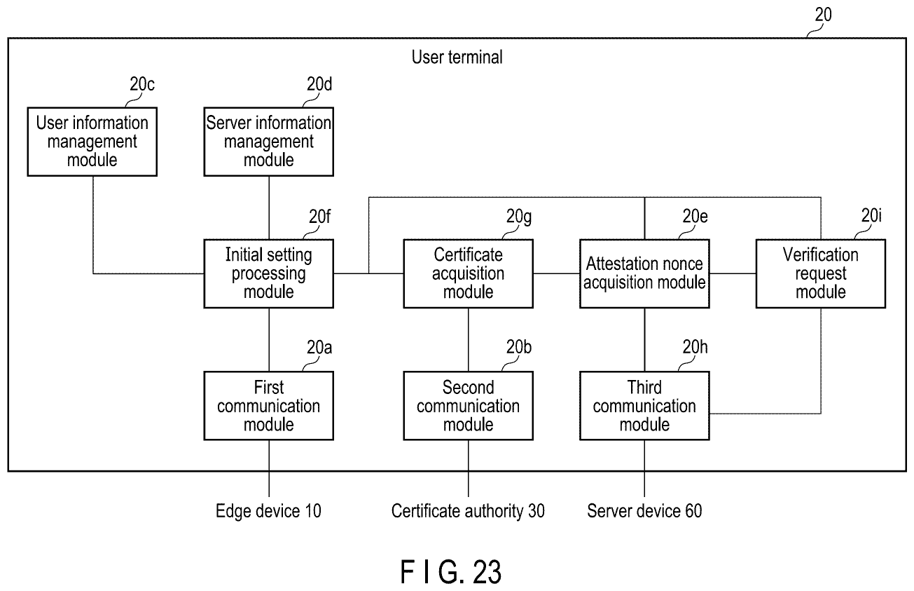

FIG. 23 shows an example of a functional configuration of a user terminal 20 according to the embodiment. In FIG. 23, portions like or similar to those shown in FIG. 4 are denoted by the same reference numerals and their detailed explanations are omitted.

As shown in FIG. 23, the user terminal 20 further includes a third communication module 20h and a verification request module 20i in comparison with the above-described first embodiment.

The third communication module 20h executes communication with the server device 60 via the network 51. Incidentally, in FIG. 23, the third communication module 20h is shown as a functional module separated from the first communication module 20a and the second communication module 20b. However, the third communication module 20h may be realized as a functional module which is the same as at least one of the first communication module 20a and the second communication module 20b. In addition, the communication method used by the third communication module 20h to execute communication may be different from or the same as the communication method used by the second communication module 20b to execute communication.

The verification request module 20i requests the server device 60 to execute verification (for example, verification of the attestation signature or the like) in the second verification process via the third communication module 20h.

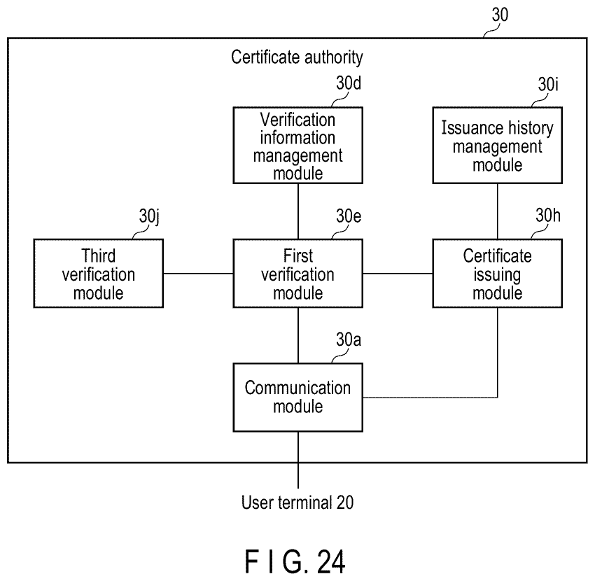

FIG. 24 shows an example of a functional configuration of the certificate authority 30 according to the embodiment. In FIG. 24, portions like or similar to those shown in FIG. 7 are denoted by the same reference numerals and their detailed explanations are omitted.

As shown in FIG. 24, the certificate authority 30 further includes a third verification module 30j in comparison with the above-described first embodiment.

In the embodiment, the server device 60 executes the verification in the second verification process, but the third verification module 30j acquires the verification results from the server device 60 via the communication module 30a and executes verification of the verification results.

In other words, as shown in FIG. 24, the attestation nonce issuing module 30b, the attestation nonce management module 30c, the attestation key management module 30f, and the second verification module 30g described in the above-described first embodiment may not be included in the certificate authority 30 (i.e., may be omitted in the certificate authority 30).

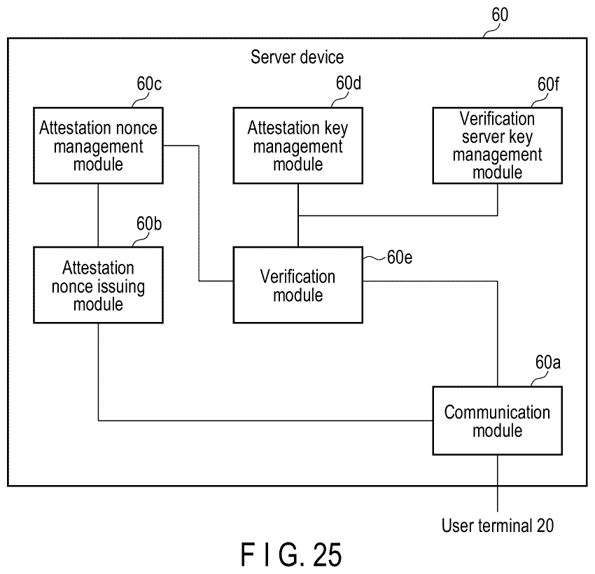

FIG. 25 shows an example of a functional configuration of the server device 60 according to the embodiment. As shown in FIG. 25, the server device 60 includes a communication module 60a, an attestation nonce issuing module 60b, an attestation nonce management module 60c, an attestation key management module 60d, a verification module 60e, and a verification server key management module 60f. The communication module 60a executes communication with the user terminal 20 via the network 51. Incidentally, in the embodiment, the server device 60 is configured to execute the verification in the second verification process instead of the certificate authority 30. The attestation nonce issuing module 60b, the attestation nonce management module 60c, the attestation key management module 60d, and the verification module 60e shown in FIG. 25 are functional modules corresponding to the attestation nonce issuing module 30b, the attestation nonce management module 30c, the attestation key management module 30f, and the second verification module 30g included in the certificate authority 30 described in the above-described first embodiment.

The verification server key management module 60f manages the private key and public key (key pair) of the server device 60 in the public key cryptography. The private key of the server device 60 managed by the verification server key management module 60f is used to generate an electronic signature attached to the verification result of the above-described verification module 60e.

The functional configuration of the user terminal 20, the certificate authority 30, and the server device 60 has been described here. Since the functional configuration of the edge device 10 in the embodiment has been described with reference to FIG. 2, its detailed descriptions are omitted.

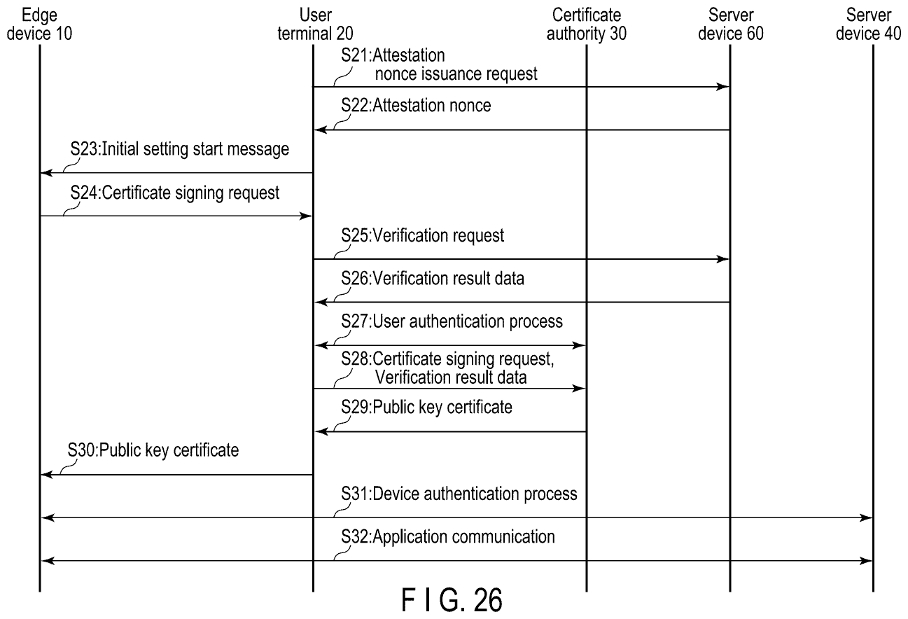

An example of the procedure of the communication system 1 according to the embodiment will be described below with reference to a sequence chart of FIG. 26.

First, the attestation nonce acquisition module 20e included in the user terminal 20 requests the server device 60 to issue the attestation nonce via the second communication module 20b. In this case, the attestation nonce issuance request is sent from the second communication module 20b to the server device 60 (step S21). Incidentally, since the attestation nonce issuance request sent in step S21 is the same as the attestation nonce issuance request sent in step S2 shown FIG. 11, its detailed descriptions are omitted here.

Incidentally, it has been described that the user authentication process is executed before the attestation nonce issuance request is sent, in FIG. 11. However, the user authentication process between the user terminal 20 and the server device 60 may be omitted. In addition, it is assumed that authentication information for connecting to the server device 60 is held in advance (installed) in the user terminal 20. The authentication information includes, for example, a pair of a user terminal ID and a shared key (a key shared by the user terminal 20 and the server device 60 for executing communication), a public key certificate, and the like. In addition, it is assumed that even when multiple users use the user terminal 20 (for example, when multiple employees use the user terminal 20 for business purposes), the user terminal 20 can be connected to the server device 60 by presenting the same authentication information.

The attestation nonce issuing module 60b included in the server device 60 accepts the attestation nonce issuance request sent in step S21 via the communication module 60a. The attestation nonce issuing module 60b issues the attestation nonce in response to the accepted attestation nonce issuance request. The attestation nonce issued by the attestation nonce issuing module 60b is sent from the communication module 60a to the user terminal 20 (step S22). Incidentally, since the attestation nonce sent in step S22 is the same as the attestation nonce sent in step S23 shown FIG. 11, its detailed descriptions are omitted here.

Next, processes in steps S23 and S24 corresponding to the above-described processes in steps S4 and S5 shown in FIG. 11 are executed.

The initial setting processing module 20f included in the user terminal 20 acquires the certificate signing request sent in step S24 via the first communication module 20a. The initial setting processing module 20f verifies the acquired certificate signing request as described above in the first embodiment. If the verification of the above-described certificate signature request is successful, the initial setting processing module 20f delivers the certificate signature request to the verification request module 20i.

The verification request module 20i acquires from the certificate signature request the device information, the attestation nonce, the attestation signature, and the attestation key ID included in the certificate signature request delivered from the initial setting processing module 20f. By sending the device information, the attestation nonce, the attestation signature, and the attestation key ID thus acquired from the certificate signature request from the third communication module 20h to the server device 60, the verification request module 20i requests the server device 60 to execute verification in the second verification process described in the first embodiment (step S25).

When the process in step S25 is executed, the verification module 60e included in the server device 60 acquires the device information, the attestation nonce, the attestation signature, and the attestation key ID sent in step S25, via the communication module 60a.

The verification module 60e executes the second verification process described in the above-described first embodiment. When the second verification process is completed, the verification module 60e generates an electronic signature for (the data including) the result of the second verification process (whether the verification executed in the second verification process is successful or failed) and the device information, using the private key of the server device 60 managed by the verification server key management module 60f. The data to which the electronic signature generated by the verification module 60e is attached for the results of the second verification process and the device information is referred to as verification result data. The verification result data is sent from the communication module 60a to the user terminal 20 (step S26).

When the process in step S26 is executed, the verification request module 20i included in the user terminal 20 acquires the verification result data sent from the server device 60 in step S26, via the third communication module 20 h. The verification request module 20i executes the verification process (hereinafter referred to as a third verification process), based on the acquired verification result data.

In this case, for example, the verification request module 20i executes verification of the electronic signature attached to the results of the second verification process and the device information, in the verification result data, using the public key of the server device 60. Incidentally, since the verification of the electronic signature is described above in the first embodiment, its detailed descriptions are omitted here.

In addition, the verification request module 20i executes verification of the verification results, which is executed in the second verification process in the verification result data. In this case, the verification request module 20i confirms whether or not the verification executed in the second verification process is successful.

If all verifications executed in the above-described third verification process are successful (pass), the process in step S27 corresponding to the process in step S6 shown in FIG. 11 is executed. If the user is authenticated by executing the process in step S27, the certificate signature request and the verification result data are sent from the second communication module 20b to the certificate authority 30 (step S28).

When the process in step S28 is executed, the first verification module 30e included in the certificate authority 30 acquires the certificate signing request and the verification result data sent from the user terminal 20 in step S28, via the communication module 30a.

In this case, the first verification module 30e executes the first verification process (i.e., verification of the certificate signature request) described above in the first embodiment. In addition, the first verification module 30e delivers the verification result data to the third verification module 30j, and the third verification module 30j executes the third verification process based on the verification result data. Incidentally, since the third verification process is the same as the above-described process described in the user terminal 20, its detailed descriptions are omitted here.

If the verifications in the first and third verification processes are successful, the certificate issuing module 30h issues the public key certificate for the edge device 10 in response to the certificate signing request delivered from the first verification module 30e as described in the first embodiment. When the public key certificate is thus issued by the certificate issuing module 30h, the issued public key certificate is sent from the communication module 30a to the user terminal 20 (step S29).

When the process in step S29 is executed, processes in steps S30 to S32 corresponding to the processes in steps S9 to S11 shown in FIG. 11 are executed.

As described above, in the embodiment, even if the server device 60 (verification server) executes the second verification process (i.e., verification of the attestation signature and the like) on behalf of the certificate authority 30, in the communication system 1, it is possible to easily issue a public key certificate for the edge device 10 in the factory default state (i.e., a public key certificate used by the edge device 10 for communication).

### Third Embodiment

Next, a third embodiment will be described. In the embodiment, detailed descriptions of the portions like or similar to the above-described first embodiment are omitted and the portions different from those of the first embodiment will be mainly described. Incidentally, since the system configuration of the communication system according to the embodiment is the same as that in FIG. 1, its detailed descriptions will be omitted and the system configuration will be described with reference to FIG. 1.

In the above-described first embodiment, the certificate authority 30 issues the attestation nonce. The embodiment is different from the first embodiment in that the user terminal 20 issues the attestation nonce.

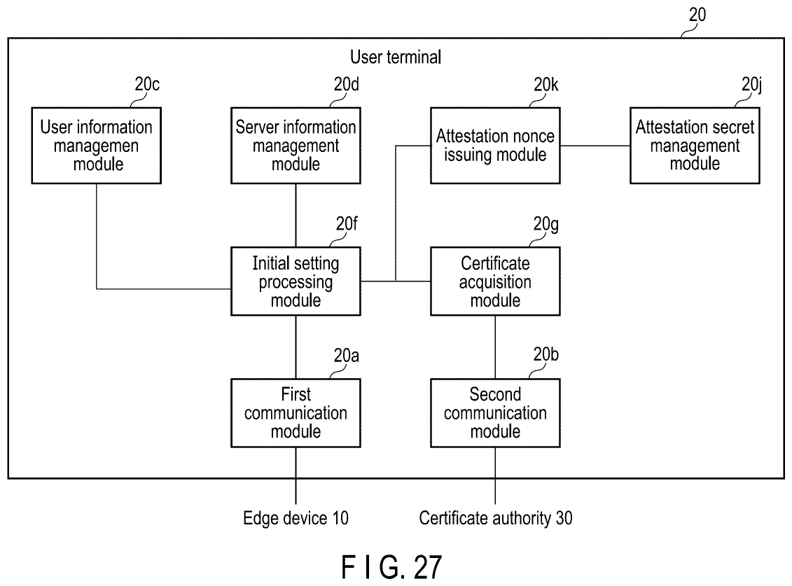

FIG. 27 shows an example of a functional configuration of a user terminal 20 according to the embodiment. In FIG. 27, portions like or similar to those shown in FIG. 4 are denoted by the same reference numerals and their detailed explanations are omitted.

As shown in FIG. 27, the user terminal 20 further includes an attestation secret management module 20j and an attestation nonce issuing module 20k in comparison with the above-described first embodiment.

In this case, in the embodiment, the user terminal 20 issues the attestation nonce. In the embodiment as well, similarly to the above-described first embodiment, the attestation signature needs to be verified using the attestation nonce. For this reason, it is assumed that in the embodiment, the user terminal 20 and the certificate authority 30 share private data (hereinafter referred to as attestation secret) in advance. The attestation secret management module 20j manages the attestation secret thus shared with the certificate authority 30. The attestation nonce issuing module 20k issues the attestation nonce generated from the attestation secret managed by the attestation secret management module 20j.

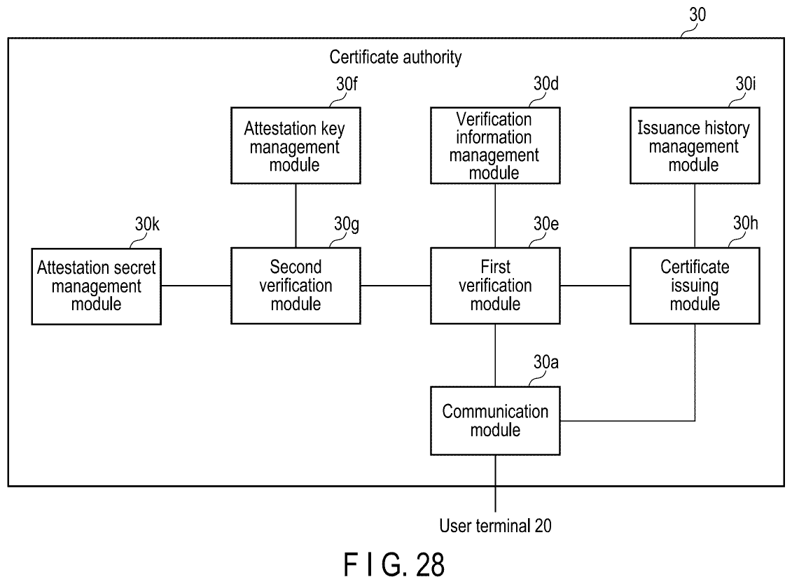

FIG. 28 shows an example of a functional configuration of the certificate authority 30 according to the embodiment. In FIG. 27, portions like or similar to those shown in FIG. 7 are denoted by the same reference numerals and their detailed explanations are omitted.

As shown in FIG. 28, the certificate authority 30 further includes an attestation secret management module 30k in comparison with the above-described first embodiment.

The attestation secret management module 30k manages the attestation secret that is shared with the user terminal 20 as described above. The attestation secret managed by the attestation secret management module 30k is used when the second verification module 30g executes the second verification process.

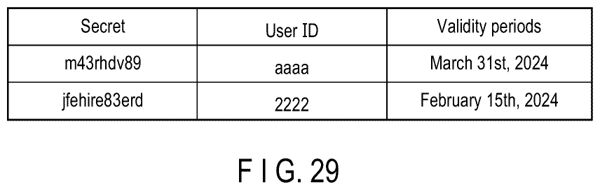

Incidentally, as shown in FIG. 29, the above-described attestation secret management modules 20j and 30k further manage the user ID for identifying the user using the user terminal 20 and the validity period of the attestation secret, in addition to (the value of) the attestation secret. Entries whose validity period has expired may be discarded at predetermined timing or may be updated to entries including a new validity period.

The attestation secret management modules 20j and 30k manage the attestation secret different for each user. In this case, for example, when the user executes initial settings of the user terminal 20, the attestation secret for the user may be generated, and the generated attestation secret may be shared between the user terminal 20 and the certificate authority 30.

The functional configurations of the user terminal 20 and the certificate authority 30 have been described. Since the functional configuration of the edge device 10 in the embodiment has been described with reference to FIG. 2, its detailed descriptions are omitted.

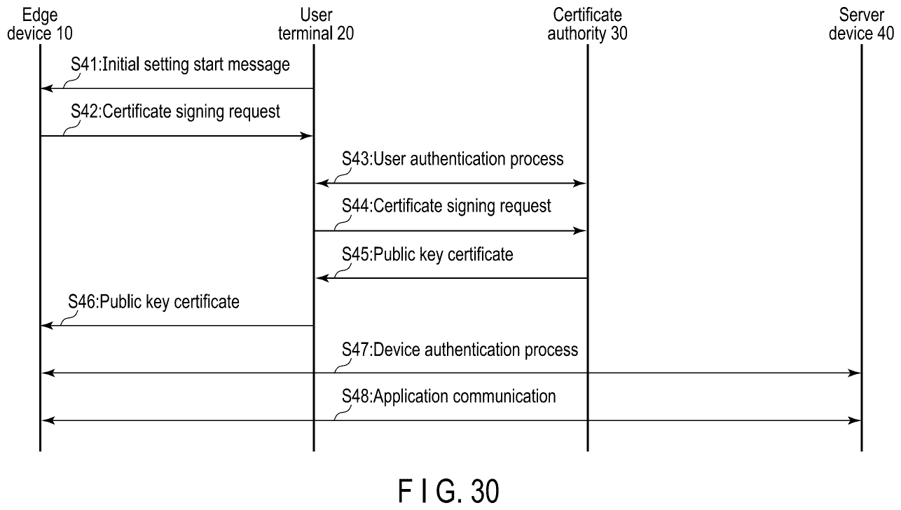

An example of the procedure of the communication system 1 according to the embodiment will be described below with reference to a sequence chart of FIG. 30.

First, for example, when the power of the edge device 10 in the factory default state is turned on, the edge device 10 becomes a state of waiting for initial settings, and it is assumed that the edge device 10 and the user terminal 20 are connected communicably with each other in response to the user's operation on the user terminal 20. When the user terminal 20 is connected to the edge device 10 in this manner, the attestation nonce issuing module 20k included in the user terminal 20 issues an attestation nonce using the attestation secret managed by the attestation secret management module 20j.

Incidentally, for example, the attestation nonce is generated by applying a predetermined algorithm to both the attestation secret corresponding to the user ID used to identify the user operating the user terminal 20 and the current time. The predetermined algorithm may be, for example, Time-Based One-Time Password Algorithm (RFC 6238).

As described above, when the attestation nonce is issued by the attestation nonce issuing module 20k, an initial setting start message including the attestation nonce is sent from the first communication module 20a to the edge device 10 in accordance with the instructions from the initial setting processing module 20f (step S41).

When the process in step S41 is executed, processes in steps S42 to S44 corresponding to the above-described processes in steps S5 to S7 shown in FIG. 11 are executed.

When the process in step S44 is executed, the first verification module 30e included in the certificate authority 30 acquires the certificate signing request transferred from the user terminal 20 in step S44, via the communication module 30a.

In this case, the first verification process is executed by the first verification module 30e. Since the first verification process is described above in the first embodiment, its detailed descriptions are omitted here.

In addition, the second verification process is executed by the second verification module 30g. In the second verification process in the embodiment, the second verification module 30g acquires the attestation secret associated with the user ID from the attestation secret management module 30k, using the user ID (i.e., user ID delivered from the first verification module 30e) used to identify the user using the user terminal 20 which has sent the certificate signature request. The second verification module 30g generates (calculates) an attestation nonce from the acquired attestation secret, and then collates the generated attestation nonce with the attestation nonce included in the certificate signing request, and verifies whether or not they match. Such verification is successful when the attestation nonce generated from the attestation secret at the certificate authority 30 (second verification module 30g) matches the attestation nonce included in the certificate signing request.

If the attestation nonce is issued by applying the Time-Based One-Time Password Algorithm (RFC 6238) to the attestation secret and the current time at the user terminal 20 as described above, the second verification module 30g may generate multiple attestation nonce by applying the RFC6238 to both the attestation secret acquired from the attestation secret management module 30k, and the current time and several points in time of the past, and verify whether one of the multiple attestation nonce thus generated matches the attestation nonce included in the certificate signing request.

Incidentally, in the second verification process executed in the embodiment, the verification of the attestation signature, the device information, and the attestation nonce described in the first embodiment may be further executed.

If the verification is successful in the first and second verification processes, the public key certificate of the edge device 10 is issued, and processes in steps S45 to S48 corresponding to the above-described processes in steps S8 to S11 shown in FIG. 11 are executed.

As described above, in the embodiment, the process of sending the attestation nonce from the certificate authority 30 to the user terminal 20 can be omitted, and the amount of communication between the user terminal 20 and the certificate authority 30 can be reduced in comparison with the above-described first embodiment, by the configuration that the user terminal 20 issues the attestation nonce generated from the attestation secret shared with the certificate authority 30.

Incidentally, in the embodiment, the portions different from the first embodiment have been mainly described. However, the embodiment may also have a configuration combined with the above-described second embodiment.

### Fourth Embodiment

Next, a fourth embodiment will be described. In the embodiment, detailed descriptions of the portions like or similar to the above-described first embodiment are omitted and the portions different from those of the first embodiment will be mainly described. Incidentally, since the system configuration of the communication system according to the embodiment is the same as that in FIG. 1, its detailed descriptions will be omitted and the system configuration will be described with reference to FIG. 1.

In the above-described first embodiment, it has been assumed that the owner of the edge device 10 executes the initial settings by communicating directly with the edge device 10 using the user terminal 20. In an environment where a large number of edge devices 10 are installed, however, it may not be practical for the owner of the edge device 10 to execute the initial settings for all of the edge devices 10. Executing the initial settings may not be practical either in a case where specialized knowledge or a certain qualification is required to install the edge device 10. In such a case, the owner of the edge device 10 may entrust (request) the other party with installation of the edge device 10. When the other party is entrusted with the installation of the edge device 10, the other party desirably executes initial settings.

Therefore, in the embodiment, a configuration in which the other party (hereinafter referred to as an agent) entrusted with the installation of the edge device 10 by the owner of the edge device 10 as described above executes the initial settings using the user terminal 20 will be described.

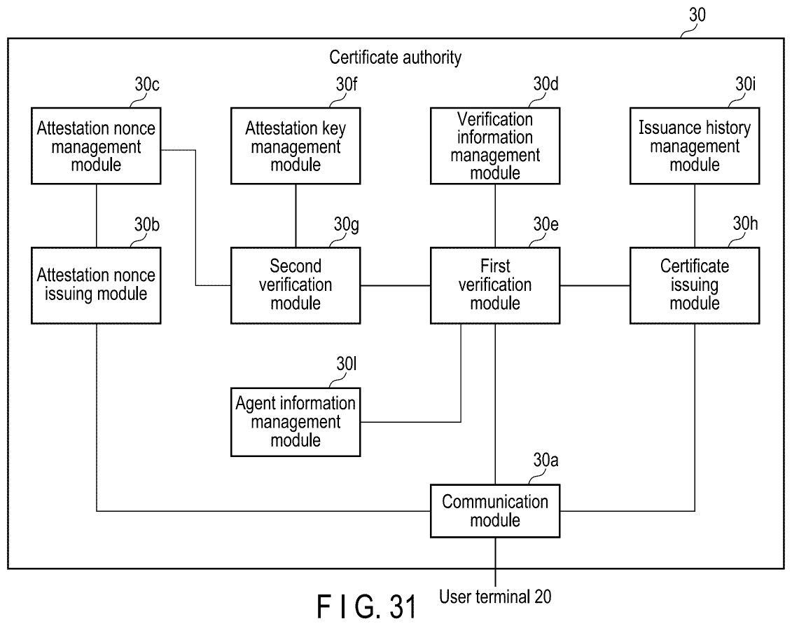

FIG. 31 shows an example of a functional configuration of the certificate authority 30 in the embodiment. In FIG. 31, portions like or similar to those shown in FIG. 4 are denoted by the same reference numerals and their detailed explanations are omitted.

As shown in FIG. 31, the certificate authority 30 further includes an agent information management module 30l in comparison with the above-described first embodiment.

The agent information management module 30l manages agent information indicating the correspondence between the owner of the edge device 10 (i.e., the entrusting party) and the agent.

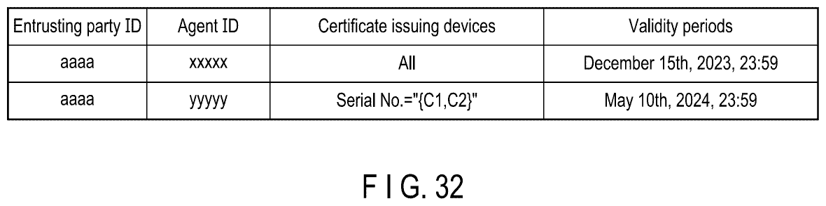

FIG. 32 shows an example of the agent information. As shown in FIG. 32, the agent information includes an entrusting party ID (user ID) for identifying the entrusting party (owner of the edge device 10) who has entrusted with the installation of the edge device 10, an agent ID (user ID) for identifying the agent who has been entrusted with the installation of the edge device 10, the certificate issuing device indicating the edge device 10 whose installation is entrusted to the agent (in other words, the edge device 10 for which the agent can issue a certificate) among the edge devices 10 owned by the entrusting party, and the validity period of the agent information (entry). Incidentally, the agent information whose validity period has expired may be discarded at predetermined timing or may be updated to agent information including a new validity period.

An example of the procedure of the communication system 1 according to the embodiment will be described below. The example will be described with reference to FIG. 11 for convenience.

First, the above-described processes in steps S1 to S7 shown in FIG. 11 are executed. Incidentally, in step S6, the user authentication process is executed for the user using the user terminal 20. Incidentally, in the embodiment, it is assumed that the user using the user terminal 20 is the agent for the installation and initial settings of the edge device 10 specified by the entrusting party. However, the user may be the entrusting party (owner of the edge device 10). The user authenticated by executing the user authentication process is hereinafter referred to as an authenticated user.

When the process in step S7 is executed, the first verification module 30e included in the certificate authority 30 acquires the certificate signing request transferred from the user terminal 20 in step S7, via the communication module 30a.

If the certificate signing request acquired by the first verification module 30e is assumed to include the user ID, the first verification module 30e confirms whether or not the user identified by the user ID (i.e., the authenticated user) is an agent by referring to the agent information managed by the agent information management module 30l. In this case, if the user ID for identifying the authenticated user is included in the agent information as agent ID, it is possible to confirm that the authenticated user is the agent.

If the authenticated user is an agent, the first verification module 30e verifies whether or not the installation and initial settings of the edge device 10 specified by the device information included in the certificate signing request has been entrusted to the agent (in other words, whether the agent has the legitimate authority to issue the public key certificate for the edge device 10), by referring to the certificate issuing device associated with the agent ID used to identify the agent.

The verification will be described in more detail using the agent information shown in FIG. 32. If a user with user ID “yyyy” transfers a certificate signing request to the certificate authority 30 (i.e., the certificate signing request includes user ID “yyyy”), the user identified by the user ID “yyyy” is the agent. If the serial number “C1” or “C2” associated with the user ID “yyyy” matches the serial number of the device information included in the certificate signing request, it is confirmed that the agent has the legitimate authority to issue the public key certificate for the edge device 10. The verification is therefore successful. In other words, if the authenticated user is the user (agent) with the user ID “yyyy”, a public key certificate can only be issued for the edge devices 10 with serial numbers “C1” and “C2” (in other words, the edge device 10 capable of issuing the public key certificate is limited).

In contrast, if the user with user ID “xxxx” transfers a certificate signing request to the certificate authority 30, the verification is successful regardless of the serial number of the device information included in the certificate signing request.

If the above-described verification does not succeed (fails), the first verification module 30e (certificate authority 30) notifies the user terminal 20 of the error.

If verifying whether or not the agent has the legitimate authority to issue the public key certificate for the edge device 10 is successful, the first verification module 30e acquires entrusting party ID associated with the agent ID for identifying the agent. The first verification module 30e executes the first verification process described above in the first embodiment using the acquired entrusting party ID.

In addition, the entrusting party ID acquired by the first verification module 30e is delivered to the second verification module 30g, and the second verification module 30g executes the second verification process described above in the first embodiment using the entrusting party ID.

In other words, in the embodiment, if the authenticated user (i.e., the user using the user terminal 20) is the agent, the certificate authority 30 can execute the verification process as if the entrusting party entrusting the agent with the installation and initial settings of the edge device 10 transferred the certificate signing request.

Incidentally, if the authenticated user is not the agent, the first and second verification processes may be executed using the user ID to identify the authenticated user, similarly to the above-described first embodiment.

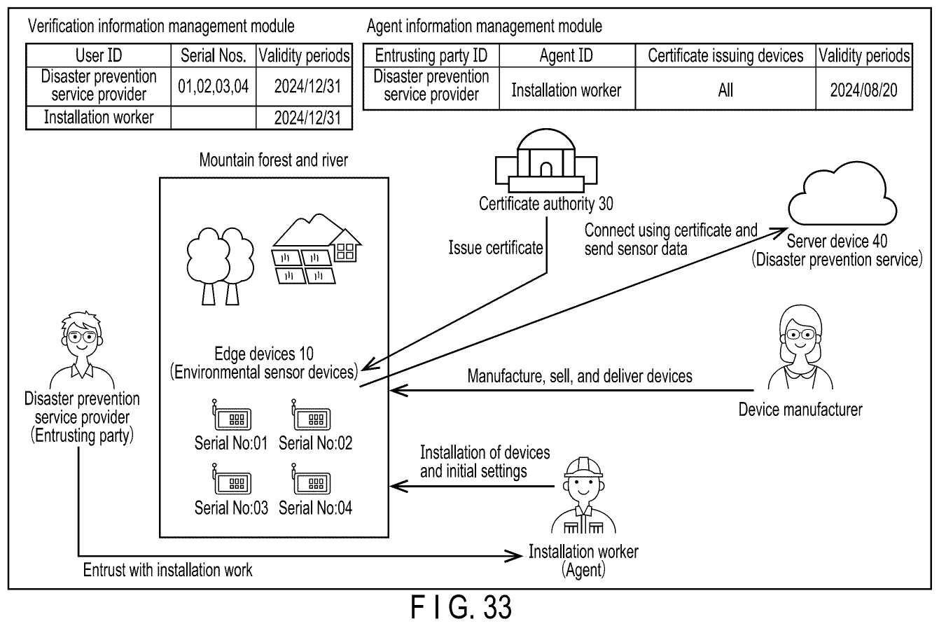

Specific usage of the communication system 1 according to the embodiment will be described below with reference to FIG. 33.

In the example shown in FIG. 33, it is assumed that, for example, environmental sensor devices installed (deployed) in a mountain forest or river operate as edge devices 10, and that the environmental sensor devices are connected to a disaster prevention service built on a cloud service (i.e., execute communication with a server device 40 that provides the disaster prevention service). Incidentally, the environmental sensor devices are sensor devices which measure sensor data related to, for example, ground movement in the mountain forest, the amount of moisture in the soil in the mountain forest, and the water level in the river, and are manufactured, sold, and delivered by the device manufacturer. In addition, the disaster prevention service corresponds to the service which predicts, for example, wind and water damage such as landslides and river flooding, and is provided by, for example, disaster prevention service providers designated by the national government or local governments.

The environmental sensor devices are connected to a network such as the Internet using wide-area wireless communication technology such as mobile phone networks, and upload (send) the sensor data measured by the environmental sensor devices to the disaster prevention service. The disaster prevention service predicts the occurrence (risk) of disasters by constantly analyzing the uploaded sensor data, and issues alerts if the occurrence of the disasters is predicted. When alerts are thus issued by the disaster prevention service, for example, the national government or local governments can take measures such as urging residents in the area where occurrence of the disasters is predicted to evacuate.

Incidentally, the above-described disaster prevention service provider purchases the environmental sensor devices from the device manufacturer in order to provide the disaster prevention services. When manufacturing the environmental sensor devices and delivers the devices to the disaster prevention service provider, the device manufacturer registers the verification information including the serial numbers of the devices, in the certificate authority 30 (verification information management module 30d).

In this case, the disaster prevention service provider needs to install the environmental sensor devices delivered by the device manufacturer in the designated mountain forest or river. However, if there are a large number of devices and the installation work of the environmental sensor devices is dangerous, it is difficult for the disaster prevention service provider to execute the installation work.

Thus, the disaster prevention service provider entrusts the installation work of the environmental sensor devices to the installation worker having appropriate experience and qualification. In this case, the disaster prevention service provider registers the agent information including the entrusting party ID for identifying the disaster prevention service provider and the agent ID for identifying the installation worker, and the like, in the certificate authority 30 (agent information management module 30l).

When the registration of the agent information is completed as described above, the installation worker installs the environmental sensor devices in the designated locations, turns on the power of the environmental sensor devices, and executes the initial settings. More specifically, the user terminal 20 used by the installation worker acquires certificate signing requests from the environmental sensor devices by sending initialization start message to the environmental sensor devices, and then transfers the acquired certificate signing requests to the certificate authority 30.

In this case, the certificate authority 30 executes the user authentication process for the installation worker using (operating) the user terminal 20 (in other words, authenticates the installation worker) and, at the same time, confirms that the installation worker is an agent who has been entrusted with the installation work (and initial settings) of the environmental sensor devices by the disaster prevention service provider, by referring to the above-described agent information. When it is confirmed that the installation worker is an agent, the certificate authority 30 executes the first and second verification processes using the entrusting party ID for identifying the disaster prevention service provider as described above, and issues the public key certificates if the verification is successful.

The public key certificates thus issued are registered in the environmental sensor devices via the user terminal 20. The environmental sensor devices are connected to the disaster prevention service, using the public key certificates registered in the environmental sensor device. Thus, providing the disaster prevention service based on the sensor data uploaded from the environmental sensor devices can be realized.

As described above, in the embodiment, even if the agent entrusted with the installation and initial settings of the edge device 10 by the entrusting party uses the user terminal 20 (in other words, the agent executes the installation and initial settings of the edge device 10 on behalf of the owner of the edge device 10), it is possible to easily issue the public key certificate for the edge device 10 in the factory default state (i.e., the public key certificate used by the edge device 10 for communication).

Incidentally, in the embodiment, the portions different from the first embodiment have been mainly described. However, the embodiment may also have a configuration combined with the above-described second or third embodiment.

According to at least one of the above-described embodiments, a communication system, a terminal device, a communication device, a certificate authority, and a method capable of easily executing issuance of a certificate used for communication can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication system comprising a communication device, a terminal device, and a certificate authority, wherein
the communication device is configured to send, to the terminal device, a certificate signing request which requests issuance of a certificate used for the communication device to communicate with a server device, and which includes device information on the communication device, an attestation nonce, and an electronic signature generated using a private key for attestation as held in advance in the communication device for the device information and the attestation nonce,
the terminal device is configured to send the certificate signing request sent from the communication device, to the certificate authority,
verification of the electronic signature included in the certificate signing request is executed using a public key for attestation, which is paired with the private key for attestation, and
the certificate authority is configured to issue the certificate in response to the verification result.

2. The communication system of claim 1, wherein
the verification of the device information included in the certificate signing request sent from the terminal device is further executed by collating the device information included in the certificate signing request sent from the terminal device with an expected value of the device information associated with the public key for attestation.

3. The communication system of claim 2, wherein
verifying whether the attestation nonce included in the certificate signing request sent from the terminal device is within a validity period is further executed.

4. The communication system of claim 1, wherein
the verification is executed by the certificate authority.

5. The communication system of claim 4, wherein
the certificate authority is configured to issue the attestation nonce in response to a request from the terminal device, and
the terminal device is configured to send to the communication device an initial setting start message including the attestation nonce issued by the certificate authority and instruct the communication device to generate the certificate signing request, when the communication device and the terminal device are connected communicably with each other.

6. The communication system of claim 1, further comprising:
a verifying server device executing the verification, wherein
the verifying server device is configured to send the verification result to the terminal device, and
the terminal device is configured to verify the verification result sent from the verifying server device and send the verification result to the certificate authority.

7. The communication system of claim 6, wherein
the verifying server device is configured to issue the attestation nonce in response to a request from the terminal device, and
the terminal device is configured to send, to the communication device, an initial setting start message including the attestation nonce issued by the verifying server device and instruct the communication device to generate the certificate signing request, when the communication device and the terminal device are connected communicably with each other.

8. The communication system of claim 1, wherein
the terminal device is configured to:
issue the attestation nonce generated from the attestation secret shared with the certificate authority; and
send, to the communication device, an initial setting start message including the issued attestation nonce and instruct the communication device to generate the certificate signing request, when the communication device and the terminal device are connected communicably with each other.

9. The communication system of claim 8, wherein
the certificate authority is configured to execute verification of the attestation nonce included in the certificate signing request sent from the terminal device by collating the attestation nonce included in the certificate signing request sent from the terminal device with the attestation nonce generated from the attestation secret shared with the terminal device.

10. The communication system of claim 1, wherein
the certificate authority is configured to, when a user using the terminal device sending the certificate signing request is an agent of initial settings of the communication device specified by an owner owing the communication device, execute verification as to whether the communication device specified by the device information included in the certificate signing request is a device owned by the owner and a device for which the agent is capable of issuing a certificate.

11. A terminal device communicably connected with a communication device and a certificate authority, the terminal device comprising a processor configured to:
receiving, from the communication device, a certificate signing request requesting issuance of a certificate used for the communication device to communicate with a server device; and
send the received certificate signing request to the certificate authority, wherein
the certificate signing request includes device information on the communication device, an attestation nonce, and an electronic signature generated using a private key for attestation as held in advance in the communication device for the device information and the attestation nonce,
verification of the electronic signature included in the certificate signing request is executed using a public key for attestation, which is paired with the private key for attestation, and
the certificate is issued by the certificate authority in response to the verification result.

12. A communication device communicably connected with a terminal device, comprising a processor configured to:
send, to the terminal device, a certificate signing request which requests issuance of a certificate used for communication with a server device, and which includes device information on the communication device, an attestation nonce, and an electronic signature generated using a private key for attestation as held in advance in the communication device for the device information and the attestation nonce, wherein
verification of the electronic signature included in the certificate signing request is executed using a public key for attestation, which is paired with the private key for attestation, and
the certificate is issued by the certificate authority in response to the verification result.

13. A certificate authority communicably connected with a terminal device, comprising a processor configured to:
receiving, from the terminal device, a certificate signing request which requests issuance of a certificate used for communication with a server device, and which includes device information on the communication device, an attestation nonce, and an electronic signature generated using a private key for attestation as held in advance in the communication device for the device information and the attestation nonce;
execute verification of the electronic signature included in the received certificate signing request, using a public key for attestation, which is paired with the private key for attestation; and
issue the certificate in response to the verification result.

14. A method executed by a communication system comprising a communication device, a terminal device, and a certificate authority, the method comprising:
sending, to the terminal device, a certificate signing request which requests issuance of a certificate used for the communication device to communicate with a server device, and which includes device information on the communication device, an attestation nonce, and an electronic signature generated using a private key for attestation as held in advance in the communication device for the device information and the attestation nonce;
sending the certificate signing request sent from the communication device, from the communication device to the certificate authority;
executing verification of the electronic signature included in the certificate signing request, using a public key for attestation, which is paired with the private key for attestation; and
issuing, at the certificate authority, the certificate in response to the verification result.

15. A method executed by a terminal device communicably connected with a communication device and a certificate authority, the method comprising:
receiving, from the communication device, a certificate signing request requesting issuance of a certificate used for the communication device to communicate with a server device; and
sending the received certificate signing request to the certificate authority, wherein
the certificate signing request includes device information on the communication device, an attestation nonce, and an electronic signature generated using a private key for attestation as held in advance in the communication device for the device information and the attestation nonce,
verification of the electronic signature included in the certificate signing request is executed using a public key for attestation, which is paired with the private key for attestation, and
the certificate is issued by the certificate authority in response to the verification result.

16. A method executed by a communication device communicably connected with a terminal device, the method comprising:
sending, to the terminal device, a certificate signing request which requests issuance of a certificate used for communication with a server device, and which includes device information on the communication device, an attestation nonce, and an electronic signature generated using a private key for attestation as held in advance in the communication device for the device information and the attestation nonce, wherein
verification of the electronic signature included in the certificate signing request is executed using a public key for attestation, which is paired with the private key for attestation, and
the certificate is issued by the certificate authority in response to the verification result.

17. A method executed by a certificate authority communicably connected with a terminal device, the method comprising:
receiving, from the terminal device, a certificate signing request which requests issuance of a certificate used for communication with a server device, and which includes device information on the communication device, an attestation nonce, and an electronic signature generated using a private key for attestation as held in advance in the communication device for the device information and the attestation nonce;
executing verification of the electronic signature included in the certificate signing request, using a public key for attestation, which is paired with the private key for attestation; and
issuing the certificate in response to the verification result.
